(19) United States
(12) Patent Application Publication
(10) Pub. No.: US 2026/0000575 A1
(43) Pub. Date: Jan. 1, 2026

(54) APPARATUS FOR THE TREATMENT OR PREVENTION OF OSTEOPENIA AND OSTEOPOROSIS, STIMULATING BONE GROWTH, PRESERVING OR IMPROVING BONE MINERAL DENSITY, AND INHIBITING ADIPOGENESIS

(71) Applicant: Bone Health Technologies, Inc., Redwood City, CA (US)

(72) Inventors: Derek HILLSTROM, Belmont, CA (US); Veda VULIGONDA, Sunnyvale, CA (US); Michael JAASMA, IRVINE, CA (US); Laura YECIES, Woodside, CA (US); Jeanette NUMBERS, Providence, RI (US); Catherine JAMESON, Providence, RI (US); Scott NOH, Cranston, RI (US); Sydney LANG, Malden, MA (US); Hannah KMETZ, Florence, MA (US); Chandlyr Jackson, South Portland, ME (US); Nari SHIN, Cranston, RI (US); Abby MCMONIGAL, Brookline, MA (US)

(73) Assignee: Bone Health Technologies, Inc., Redwood City, CA (US)

(21) Appl. No.: 19/316,584

(22) Filed: Sep. 2, 2025

Related U.S. Application Data
(63) Continuation of application No. PCT/US2024/019201, filed on Mar. 8, 2024.
(60) Provisional application No. 63/451,827, filed on Mar. 13, 2023.

(51) Int. Cl. A61H 23/02

(52) U.S. Cl. CPC A61H 23/0263; A61H 2201/1215; A61H 2201/165; A61H 2201/5007; A61H 2201/5043; A61H 2201/5061; A61H 2201/5084; A61H 2205/088

(57) ABSTRACT

Apparatus for the treatment or prevention of osteopenia and osteoporosis, stimulating bone growth, preserving or improving bone mineral density, and inhibiting adipogenesis are disclosed herein. The wearable apparatus may generally comprise a housing containing a motor and one or more vibrating elements which are configured to impart repeated mechanical loads to a body of a user when actuated by the motor, one or more securing mechanisms for securing the housing to the user such that the housing is maintained against the body while maintaining portability, a first accelerometer in proximity to the motor, a controller in electrical communication with the first accelerometer, wherein the controller is configured to determine a 10 vertical orientation of the motor relative to horizontal based on a first signal from the first accelerometer and wherein the controller is further configured to provide an indicator when the vertical orientation of the motor is beyond a threshold limit.

### CROSS-REFERENCE TO RELATED APPLICATIONS

This application is a continuation of PCT/US2024/019201 filed Mar. 8, 2024, which claims the benefit of priority to U.S. Prov App. 63/451,827 filed Mar. 13, 2023, which is incorporated herein by reference in its entirety.

### FIELD OF THE INVENTION

The present invention relates generally to the stimulation of bone growth, healing of bone tissue, and treatment and prevention of osteopenia, osteoporosis, cartilage and chronic back pain, and to preserving or improving bone mineral density, and to inhibiting adipogenesis particularly by the application of repeated mechanical loading to bone tissue.

### INCORPORATION BY REFERENCE

All publications and patent applications mentioned in this specification are herein incorporated by reference to the same extent as if each such individual publication or patent application were specifically and individually indicated to be so incorporated by reference.

### BACKGROUND OF THE INVENTION

Osteopenia is a highly common skeletal condition with accelerated loss of bone mass leading to osteoporosis if not treated. Characterized by below normal bone mineral density (BMD, osteopenia is defined by a BMD T-score of −1.0 to −2.49), osteopenia affects 43 million Americans. If BMD loss is not mitigated, patients become osteoporotic (as defined by a BMD T-score of ≤2.5) with risk of serious clinical consequences due to fractures. Approximately 50% of women and 25% of men aged 50 years and older will have an osteoporosis-related bone fracture, accounting for $19 billion in healthcare costs every year. In addition, while women with osteoporosis are at the greatest risk of fracture, a greater number of bone fractures occur in osteopenic women due to the higher prevalence of osteopenia. Hip and spine fractures are two of the most common types of osteoporosis-related fractures, with over 300,000 hip fractures and over 700,000 spine fractures per year in the United States. Bone fractures, particularly of the proximal femur, result in disability, with significant impact on the capacity to live independently. Furthermore, mortality associated with osteoporotic fractures ranges from 15 to 30%. Mitigating continued bone loss in the early stages of low bone mass is of paramount importance to prevent the onset and devastating sequelae associated with osteoporosis.

Despite the high prevalence of osteopenia, few treatment options exist. Current clinical practice guidelines for patients with osteopenia include initiating both dietary modifications (e.g. increased calcium and vitamin D intake) and discussing the importance of high impact exercise. Recent evidence has shown that calcium and vitamin D alone do not decrease fracture risk. While the combination of diet/supplements and exercise are effective in maintaining bone mass, daily compliance with weight-bearing exercise that effectively stimulates bone cells to mitigate bone loss is low in aging populations. In addition to issues with compliance, vigorous aerobic or strength training exercises may increase risk of injury in susceptible individuals. Alternatively, medication is offered to treat bone loss associated with osteoporosis. Bisphosphonates and RANK-L inhibitors, which inhibit osteoclastic bone resorption or osteoclast maturation, respectively, are widely prescribed and effective at limiting bone mass loss. However, there are concerns that prolonged use of these drugs increases the risk of serious adverse events, including osteonecrosis of the jaw and atypical subtrochanteric and diaphyseal femur fractures. Accordingly, these pharmaceuticals are typically not prescribed until bone mass reaches osteoporotic, or near-osteoporotic, levels when their antifracture benefits considerably outweigh their potential for harm. In addition, due to these more serious side effects and less serious, but still inconvenient, side effects, (e.g. abdominal pain, nausea), 22-82% of patients discontinue pharmaceutical use within 12 months of initiating treatment. Therefore, there remains a need for a safe, effective, and convenient treatment for osteopenia that can prevent the early progression of bone loss prior to a patient reaching the osteoporotic state.

Dynamic mechanical loading of the skeleton is a key factor in the body's regulation of bone mass. Bone cells, both osteoblasts and osteoclasts, have been shown to respond to many forms of mechanical loading. Mechanical vibration has been shown to have stimulatory effects at the bone tissue level in both animal and clinical studies. Animal studies in rat, turkey, and sheep models have shown that vibration at 30-90 Hz (hertz) is a potent stimulator of bone formation in long bones of the appendicular skeleton. Clinically, whole body vibration (WBV) platforms have been developed to apply vibration to the body through a vibrating platform that the individual stands on.

Despite promising results with WBV platforms, these devices have two key drawbacks. First, current WBV platforms require the user to stand on the platform for at least 20 minutes per day and at least three days per week. This regimen can be a major obstacle to treatment compliance and, accordingly, treatment effectiveness. Accordingly, a more convenient vibration therapy could have improved outcomes.

A second drawback of current WBV platforms is the trade-off between safe and effective vibration levels. WBV platforms rely on vibration being transferred from the feet to the hips and spine. It has been shown that the vibration magnitude dampens as it is transmitted up the skeleton. Therefore, vibration at the platform needs to be higher than the therapeutic level at the hips and spine. However, there are safety concerns with regular exposure to higher WBV levels.

While the relationships between vibration magnitude, duration/frequency of exposure, and safety are hypothesized, they are poorly understood and generally unproven, particularly for exposure under 4 hr/day. ISO 2631-1 (International Standard for Mechanical vibration and shock-Evaluation of human exposure to whole-body vibration) is focused on providing guidelines for safe levels of vibration transmitted through the body via the supporting structure when the individual is standing or sitting for 4-8 hr/day (e.g. heavy machine operators, factory workers). Nonetheless, ISO 2631-1 includes guidelines for extrapolating to shorter periods of exposure. Taking these into account, while effective, high vibration levels may be unsafe in the long-term. Accordingly, a more direct means of transmitting vibration to the hips and spine that allows for an overall lower magnitude of vibration to the individual, may provide a safe and effective therapy for treating low bone mass.

Additionally, a portable device, vs. a stationary device may be desired.

### SUMMARY OF THE INVENTION

A wearable vibration device provides a novel method and apparatus for the stimulation of bone growth, healing of bone tissue, and prevention of osteoporosis, osteopenia, and chronic back pain. The wearable vibration device may maintain or promote bone-tissue growth, may prevent the onset of osteoporosis, cartilage and may treat chronic back pain.

In some embodiments of the wearable vibration device, the device provides effective treatment by targeted application of oscillating mechanical loads to the hip and spine of a user. In some embodiments, the device is worn over, and the vibration is focused on, the sacrum.

The wearable vibration device allows for delivery of WBV stimulus in side-to-side, front-to-back, and/or in inferior-superior directions. This flexibility in the delivery system allows for better targeting of the hips and spine in the treatment of osteoporosis and loss of BMD. More specifically in one variation, one or more vibrating elements may be positioned against the patient's body via one or more securing mechanisms, respectively, which are configured to position the vibrating elements in a direction lateral to the individual's body such that the mechanical loads are applied laterally to the patient. The fit of the device may be monitored by various sensors and the vibrational energy may be adjusted to compensate for less than optimal fit.

In addition, a wearable device provides the user with more ambulatory options than a stationary device.

One variation of a vibration apparatus for treating a subject may generally comprise an actuator configured to generate vibrational energy, a securing mechanism for positioning the actuator upon the body of the subject while maintaining portability such that the vibrational energy generated by the actuator is directed into an area of the body of the subject to be treated, and a controller in communication with the actuator, wherein the controller is programmed to determine an exposure level of the vibrational energy to the area of the body for comparison against a maximum exposure level such that the exposure level is limited by the maximum exposure level within a predetermined period of time.

Another variation of the vibration apparatus may generally comprise an actuator configured to generate vibrational energy and a securing mechanism for positioning the actuator upon the body of the subject while maintaining portability such that the vibrational energy generated by the actuator is directed into an area of the body of the subject to be treated. A first accelerometer may be positioned in proximity to the area of the body of the subject and configured to detect a resultant vibrational energy transmitted into the area of the body of the subject. Additionally, a controller may be in communication with the actuator and the first accelerometer, wherein the controller is programmed to receive a signal indicative of the resultant vibrational energy from the first accelerometer and automatically calibrate the actuator to adjust the generated vibrational energy until the resultant vibrational energy is within a predetermined range.

One variation for a method for treating a subject may generally comprise generating vibrational energy from an actuator such that the vibrational energy is directed into an area of a body of the subject while maintaining portability of the actuator, monitoring the vibrational energy transmitted into the area of the body via a controller, determining an exposure level via the controller of the vibrational energy transmitted into the area of the body for comparison against a maximum exposure level such that the exposure level is limited by the maximum exposure level within a predetermined period of time, and transmitting the vibrational energy into the area of the body to be within the maximum exposure level.

Another method for treating the subject may generally comprise generating vibrational energy from an actuator such that the vibrational energy is directed into an area of a body of the subject while maintaining portability of the actuator, monitoring a resultant vibrational energy transmitted into the area of the body of the subject via a first accelerometer positioned in proximity to the area of the body, wherein the first accelerometer and the actuator are in communication with a controller, and automatically calibrating the actuator via the controller by adjusting the vibrational energy until the resultant vibrational energy is within a predetermined range.

In yet another variation, the wearable apparatus for preserving or improving bone density may generally comprise a housing containing a motor and one or more vibrating elements which are configured to impart repeated mechanical loads to a body of a user when actuated by the motor, one or more securing mechanisms for securing the housing to the user such that the housing is maintained against the body while maintaining portability, a first accelerometer in proximity to the motor, a controller in electrical communication with the first accelerometer, wherein the controller is configured to determine a vertical orientation of the motor relative to horizontal based on a first signal from the first accelerometer and wherein the controller is further configured to provide an indicator when the vertical orientation of the motor is beyond a threshold limit.

In another aspect of the wearable apparatus, the one or more securing mechanisms may be configured for securing the housing against a hip, femur, and/or spine of the user.

In another aspect of the wearable apparatus, the apparatus may further comprise a second accelerometer in electrical communication with the controller, wherein the second accelerometer is secured to the one or more securing mechanisms so as to become aligned with a hip of the user when the housing is secured to the user.

In another aspect of the wearable apparatus, the controller may be further configured to determine a vertical orientation of the hip of the user based on a second signal from the second accelerometer.

In another aspect of the wearable apparatus, the controller may be further configured to provide a second indicator when the vertical orientation of the hip is beyond a second threshold limit.

In another aspect of the wearable apparatus, the controller may be further configured to provide the indicator when the vertical orientation of the hip is beyond a second threshold limit.

In another aspect of the wearable apparatus, the apparatus may further comprise a force sensor in electrical communication with the controller, wherein the force sensor is configured to be positioned between the housing and the body of the user.

In another aspect of the wearable apparatus, the controller may be further configured to determine a force applied by the housing upon the body of the user based on a third signal from the force sensor.

In another aspect of the wearable apparatus, the controller may be further configured to provide a third indicator when the force is below a third threshold limit.

In another aspect of the wearable apparatus, the controller may be further configured to provide the indicator when the force is below a third threshold limit.

In another aspect of the wearable apparatus, the controller may be further configured to provide a fourth indicator when the force is unstable.

In another aspect of the wearable apparatus, the controller may be further configured to provide the indicator when the force is unstable.

In another aspect of the wearable apparatus, the controller may be further configured to determine a vertical orientation of the hip of the user based on a second signal from a second accelerometer secured to the one or more securing mechanisms so as to become aligned with a hip of the user when the housing is secured to the user.

In another aspect of the wearable apparatus, the controller may be further configured to determine a force applied by the housing upon the body of the user based on a third signal from a force sensor configured to be positioned between the housing and the body of the user.

In another aspect of the wearable apparatus, the controller may be further configured to determine a force applied by the housing upon the body of the user based on a third signal from a force sensor configured to be positioned between the housing and the body of the user.

In another aspect of the wearable apparatus, the controller may be further configured to provide a fourth signal based on the force sensor when the force is unstable.

In another aspect of the wearable apparatus, the controller may be configured to provide the indicator based on the first signal, second signal, third signal, or fourth signal where each signal is alone or in combination with one another.

In another aspect of the wearable apparatus, the one or more securing mechanisms may comprise a belt configured to be worn around the body of the user.

In another aspect of the wearable apparatus, the housing may be removable from the one or more securing mechanisms.

In another aspect of the wearable apparatus, the housing may be removably secured within a pouch along the one or more securing mechanisms.

In another aspect of the wearable apparatus, the apparatus may further comprise a foam pad attachable to the housing.

In another aspect of the wearable apparatus, the one or more securing mechanisms may define an opening through which the foam pad is extendable.

In another aspect of the wearable apparatus, the housing may be securable to the one or more securing mechanisms via a magnet.

In another aspect of the wearable apparatus, the housing may be securable to the one or more securing mechanisms via one or more snaps.

In another aspect of the wearable apparatus, the housing may be securable to the one or more securing mechanisms via one or more clips.

In another aspect of the wearable apparatus, any of the individual features above may be combined in any number of combinations and such combinations are intended to be fully within the scope of this disclosure.

In yet another variation of the wearable apparatus for preserving or improving bone density, the wearable apparatus may generally comprise a housing containing a motor and one or more vibrating elements which are configured to impart repeated mechanical loads to a body of a user when actuated by the motor, one or more securing mechanisms comprising a receiving channel for removably receiving the housing, wherein the receiving channel is positioned to maintain the housing against the body while maintaining portability, a first accelerometer in proximity to the motor, and a controller in electrical communication with the first accelerometer.

In another aspect of the wearable apparatus, the one or more securing mechanisms may be configured for securing the housing against a hip, femur, and/or spine of the user.

In another aspect of the wearable apparatus, the controller may be configured to determine a vertical orientation of the motor relative to horizontal based on a first signal from the first accelerometer and wherein the controller is further configured to provide an indicator when the vertical orientation of the motor is beyond a threshold limit.

In another aspect of the wearable apparatus, the wearable apparatus may further comprise a second accelerometer in electrical communication with the controller, wherein the second accelerometer is secured to the one or more securing mechanisms so as to become aligned with a hip of the user when the housing is secured to the user.

In another aspect of the wearable apparatus, the controller may be further configured to determine a vertical orientation of the hip of the user based on a second signal from the second accelerometer.

In another aspect of the wearable apparatus, the controller may be further configured to provide a second indicator when the vertical orientation of the hip is beyond a second threshold limit.

In another aspect of the wearable apparatus, the wearable apparatus may further comprise a force sensor in electrical communication with the controller, wherein the force sensor is configured to be positioned between the housing and the body of the user.

In another aspect of the wearable apparatus, the controller may be further configured to determine a force applied by the housing upon the body of the user based on a third signal from the force sensor.

In another aspect of the wearable apparatus, the controller may be further configured to provide a third indicator when the force is below a third threshold limit.

In another aspect of the wearable apparatus, the controller may be further configured to provide a fourth signal when the force is unstable.

In another aspect of the wearable apparatus, the controller may be further configured to provide a fourth indicator based on the force sensor when the force is unstable.

In another aspect of the wearable apparatus, the controller may be configured to provide the indicator based on the first signal, second signal, third signal, or fourth signal where each signal is alone or in combination with one another.

In another aspect of the wearable apparatus, the one or more securing mechanisms may comprise a belt configured to be worn around the body of the user.

In another aspect of the wearable apparatus, the housing may be removable from the one or more securing mechanisms.

In another aspect of the wearable apparatus, the housing may be removably secured within a pouch along the one or more securing mechanisms.

In another aspect of the wearable apparatus, the wearable apparatus may further comprise a foam pad attachable to the housing.

In another aspect of the wearable apparatus, the one or more securing mechanisms may define an opening through which the foam pad is extendable.

In another aspect of the wearable apparatus, the housing may be securable to the one or more securing mechanisms via a magnet.

In another aspect of the wearable apparatus, the housing may be securable to the one or more securing mechanisms via one or more snaps.

In another aspect of the wearable apparatus, the housing may be securable to the one or more securing mechanisms via one or more clips.

In another aspect of the wearable apparatus, any of the individual features above may be combined in any number of combinations and such combinations are intended to be fully within the scope of this disclosure.

Yet another method of preserving or improving bone density may generally comprise providing one or more securing mechanisms for securing a housing to a body of a user such that the housing is maintained against the body while maintaining portability, wherein the housing contains a motor and one or more vibrating elements which are configured to impart repeated mechanical loads to the body when actuated by the motor, receiving via a controller a first signal from a first accelerometer which is in proximity to the motor, determining via the controller a vertical orientation of the motor relative to horizontal based on the first signal from the first accelerometer, and providing an indicator when the vertical orientation of the motor is beyond a threshold limit.

In another aspect of the method, the one or more securing mechanisms may be configured for securing the housing against a hip, femur, and/or spine of the user.

In another aspect of the method, the method may further comprise receiving via the controller a second signal from a second accelerometer in electrical communication with the controller, wherein the second accelerometer is secured to the one or more securing mechanisms so as to become aligned with a hip of the user when the housing is secured to the user.

In another aspect of the method, the method may further comprise determining via the controller a vertical orientation of the hip of the user based on the second signal from the second accelerometer.

In another aspect of the method, the method may further comprise providing a second indicator when the vertical orientation of the hip is beyond a second threshold limit.

In another aspect of the method, the method may further comprise receiving via the controller a third signal from a force sensor in electrical communication with the controller, wherein the force sensor is configured to be positioned between the housing and the body of the user.

In another aspect of the method, the method may further comprise determining via the controller a force applied by the housing upon the body of the user based on the third signal from the force sensor.

In another aspect of the method, the method may further comprise providing a third indicator when the force is below a third threshold limit.

In another aspect of the method, the controller may be further configured to provide a fourth signal when the force is unstable.

In another aspect of the method, the controller may be further configured to provide a fourth indicator based on the force sensor when the force is unstable.

In another aspect of the method, the controller may be configured to provide the indicator based on the first signal, second signal, third signal, or fourth signal where each signal is alone or in combination with one another.

In another aspect of the method, the housing may be removable from the one or more securing mechanisms.

In another aspect of the method, the housing may be removably secured within a pouch along the one or more securing mechanisms.

In another aspect of the method, the housing may be securable to the one or more securing mechanisms via a magnet.

In another aspect of the method, the housing may be securable to the one or more securing mechanisms via one or more snaps.

In another aspect of the method, the housing may be securable to the one or more securing mechanisms via one or more clips.

In another aspect of the method, any of the individual features above may be combined in any number of combinations and in any order and such combinations are intended to be fully within the scope of this disclosure.

### BRIEF DESCRIPTION OF THE DRAWINGS

FIG. 1 shows an embodiment of the wearable vibration device.

FIGS. 2A-B show various views of an embodiment of the wearable vibration device.

FIG. 3 shows the top view of an embodiment of the wearable vibration device.

FIGS. 4A-C show various views of an embodiment of the wearable vibration device.

FIGS. 5A-C show various views of an embodiment of the wearable vibration device.

FIG. 6 shows a logical diagram of the function of an embodiment of the wearable vibration device.

FIG. 7 shows a diagram of the various components of an embodiment of the wearable vibration device.

FIG. 8 shows an embodiment of the vibration device which is in the form of a seat covering.

FIG. 9 shows an embodiment of the vibration device which includes a foam platform with protuberance.

FIGS. 10A-C show different views of another embodiment of the foam platform and protuberance.

FIGS. 11A-C show different views of another embodiment of the foam platform and protuberance, along with some example dimensions in inches.

FIG. 12 shows an embodiment of the belt of the device.

FIG. 13 shows an embodiment of the vibration pack.

FIG. 14 shows control logic of some embodiments as represented by a flowchart.

FIGS. 15 and 16 show 2 different embodiments of the wearable vibration device.

FIG. 17 shows an expanded view of the embodiment shown in FIG. 16.

FIG. 18 shows an embodiment of the device with a window in the fabric outer layer through which the housing of the vibration device may be accessed.

FIG. 19 shows a side view of an embodiment of the wearable vibration device.

FIGS. 20 and 21 show the embodiment of the device shown in FIG. 19 in place on a subject.

FIGS. 22A-22C show possible locations of an accelerometer on the device.

FIGS. 23A-C show another embodiment of the wearable vibration device.

FIGS. 24 and 25 show cross-sectional side-view detail of another embodiment of the wearable vibration device.

FIGS. 26 and 27 show the steps that the controller steps through to determine whether the wearable vibration device is properly strapped to the user before treatment is initiated.

FIG. 28 shows an embodiment of the wearable vibration device with a flexible enclosure

FIG. 29 shows an alternative view of the device in FIG. 28.

FIGS. 30A-30D show various views of an embodiment of the wearable vibration device.

FIGS. 31A-31C show various views of an embodiment of the wearable vibration device.

FIG. 32 is a block diagram of a data processing system, which may be used with any embodiments of the invention.

### DETAILED DESCRIPTION OF THE INVENTION

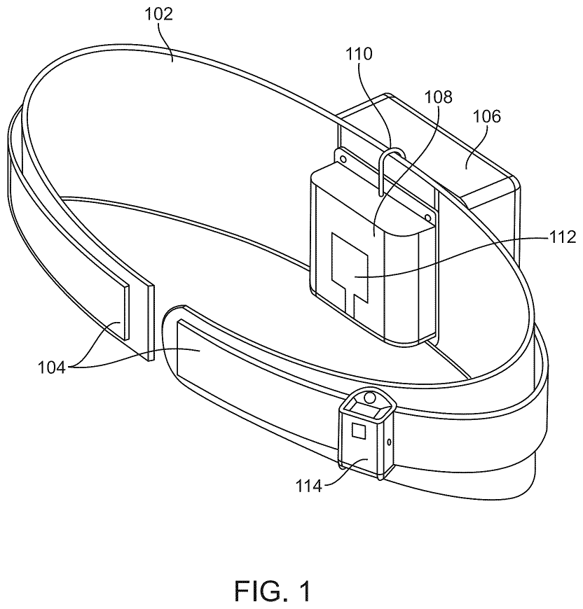

FIG. 1 shows an embodiment of the wearable vibration device. This embodiment is designed to be worn around the waist so that the vibrational energy is applied to the user's hip/spine area. In some embodiments, the device is worn so that the vibrational energy is focused on the sacrum. Band p may be secured to the body via securing mechanisms, or straps, 104. Container or enclosure 106 of the vibration pack may contain the vibrational motor, processor, battery, battery charger, voltage regulator, buzzer or alarm, motor sensor, thermal switch and other components and/or electronics. Container or enclosure 106 is secured to band 102 and connected to pressure sensor 112 via connector 110. Dampening, or foam, block, or spacer 108 serves to direct the vibrational energy more precisely toward a certain area of the user and also to increase the comfort for the user while using the wearable vibration device. The pressure sensor may be on top of or below the foam. Accelerometer 114 monitors the vibrational forces which are transferred through the body to determine whether the fit of the wearable vibration device is correct. The accelerometer(s) may be on the inside, outside, or embedded within band 102. The accelerometer may also assess effectiveness of the application of vibrational forces to the user. Pressure sensor 112 may also serve this purpose by determining the pressure of the device against the body. The measured pressure is indicative of the fit of the device.

In some embodiments, there is more than one pressure or force sensor to sense fit. In some embodiments, there is an array of pressure/force sensors to sense fit. Using multiple sensors, fit can be assessed more precisely. For example, the controller may be able to sense if the device is situated too high, too low, too far to the left, too far to the right, too loose, too tight, or some combination of these. The controller may communicate to the user how to adjust the device to improve the fit. The controller may indicate to move the device up, down, left, right, to tighten or loosen the device.

The fit of the wearable vibration device is important to ensure proper function. For example, if the wearable vibration device is too loose or too tight on the body, the proper amount of vibrational energy may not be transferred to the bone(s), or the energy may be transferred to the wrong location, or the energy may be transferred in the wrong direction. In addition, the comfort to the user of the device may be compromised if the fit is not correct.

To ensure proper fit, the wearable vibration device may include one or more than one sensor. These sensors may include, but are not limited to: contact sensor(s), pressure sensor(s), strain gauge(s), accelerometer(s), and gyroscope(s). A sensor or sensors may be placed anywhere on the wearable vibration device, including the straps, bands, securing mechanism, motor, spacer, container etc. in some embodiments, a sensor may be physically separate from the device, but in wired or wireless communication with the controller of the device. In addition, an alarm or alarms may be included in the wearable vibration device to alert the user to adjust the fit. Various types of alarms may be used, including audible, visible, such as a blinking light, tactile, such as a pulsing of the vibrational motor, etc. The alarm may sound for a set period of time, or until the fit is improved, or both. In addition, or alternatively, the securing mechanism of the wearable vibration device may be self-adjusting based on the feedback from the fit sensor(s). This may be achieved with a motor, a thermal mechanism, a mechanical mechanism, an electrical mechanism etc.

Alternatively or additionally, if the fit is not providing the optimal vibrational energy transfer, the processor of the wearable vibration device may adjust the movement of the motor to increase or decrease the vibrational energy being transferred to the user. In this way the optimal treatment vibrational energy may be optimized automatically even if the fit changes during the treatment.

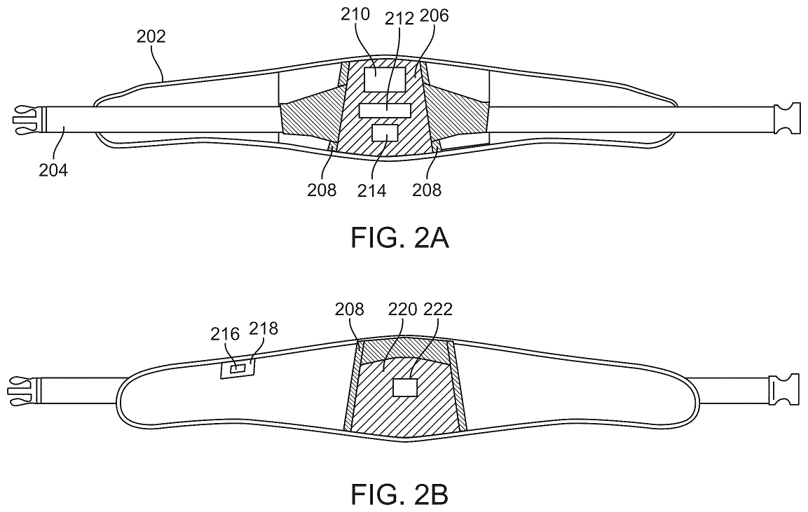

FIGS. 2A-B show two views of an embodiment of the wearable vibration device. FIG. 2A shows the side of the wearable vibration device which faces away from the user. Band 202 may be secured to the body via securing mechanisms, or straps, 204. Container, pouch, or pocket, 206 contains motor 212, electronics 210 and battery 214. Boning 208 helps hold the contents of pocket 206 securely and helps provide rigidity to the wearable vibration device.

FIG. 2B shows the side of the wearable vibration device which faces toward the user, so is in contact with the user's body. Container, pouch, or pocket 220 holds the spacer mentioned in FIG. 1. Pressure sensor 222 senses the measures the pressures caused by the vibration of the motor in pocket 206 as well as the overall tightness, or fit, of the wearable vibration device on the user's body. Pressure sensor(s) may also, or instead, be placed on other areas of the wearable vibration device. Accelerometer 216 is held in pocket, or slot, 218 and is for monitoring the fit of the wearable vibration device and/or the effectiveness of the transfer of vibrational forces to the user. One or more various sensors may be placed at various locations on the wearable vibration device to monitor the fit of the device.

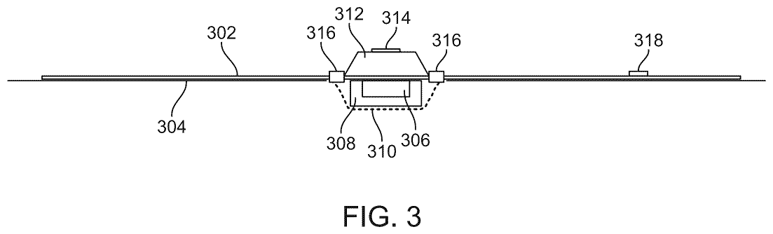

FIG. 3 shows a top view of an embodiment of the wearable vibration device. Band 302 may be secured to the body via securing mechanisms, or straps, 304. Motor 306 and other electronics and components are contained in container 308 inside pocket 310. Spacer 312 and pressure sensor 314 are on the inside of the wearable vibration device. Boning 316 helps hold the contents of pocket 310 securely and helps provide rigidity to the wearable vibration device. Accelerometer 318 aids in monitoring the fit of the wearable vibration device and/or the effectiveness of the transfer of vibrational forces to the user.

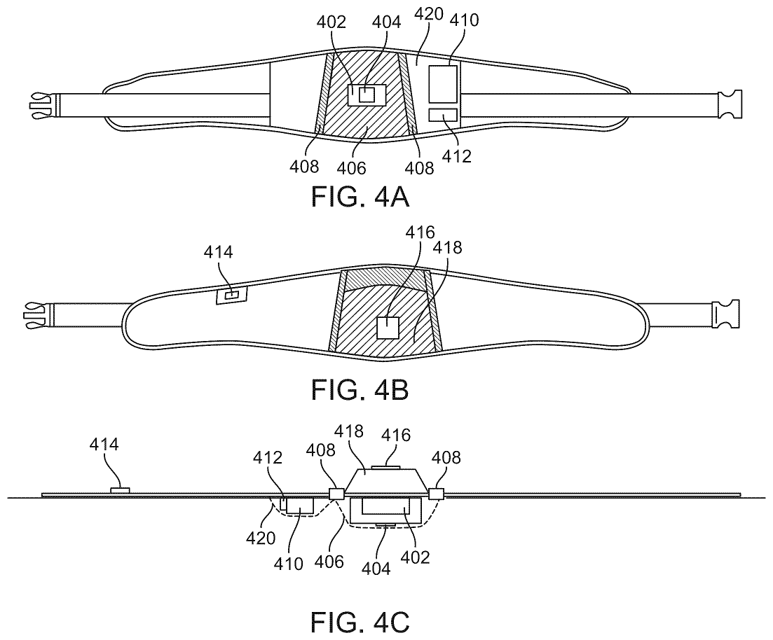

FIGS. 4A-C show various views of an embodiment of the wearable vibration device. FIG. 4A shows the side of the wearable vibration device which faces away from the user. Container, pouch, or pocket, 406 contains motor 402 and motor sensor 404. Pouch, or pocket, 420 contains electronics 410 and battery 412. Boning 408 helps hold the contents of pocket 406 securely and helps provide rigidity to the wearable vibration device. Accelerometer 414 aids in monitoring the fit of the wearable vibration device and/or the effectiveness of the transfer of vibrational forces to the user.

FIG. 4B shows the side of the wearable vibration device which faces toward the user, so is in contact with the user's body. Container, pouch, or pocket 418 holds the spacer mentioned in FIG. 1. Pressure sensor 416 senses the measures the pressures caused by the vibration of the motor in pocket 406 as well as the overall tightness of the wearable vibration device on the user's body. Pressure sensor(s) may also, or instead, be placed on other areas of the wearable vibration device. Accelerometer 414 is for monitoring the fit of the wearable vibration device and/or the effectiveness of the transfer of vibrational forces to the user.

FIG. 4C shows the bottom view of the device in FIGS. 4A and 4B.

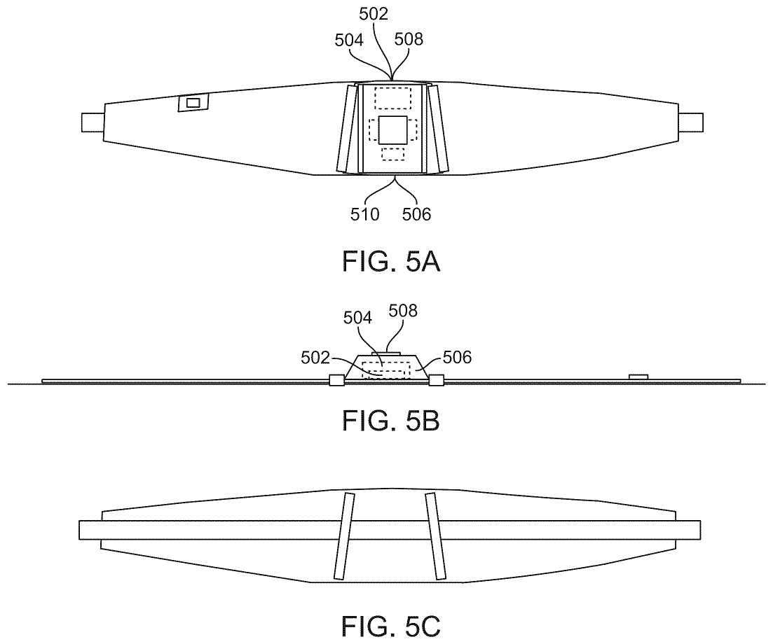

FIGS. 5A-C show various views of an embodiment of the wearable vibration device.

FIG. 5A shows the side of the wearable vibration device which faces toward the user, so is in contact with the user's body. In this embodiment spacer device 506 holds motor 504, electronics 502 and battery 510. Pressure sensor 508 is on the outside of the spacer so it is in contact with the user. Pressure sensor 508 senses the measures the pressures caused by the vibration of the motor as well as the overall tightness of the wearable vibration device on the user's body, before, during or after the motor is turned on. Pressure sensor(s) may also, or instead, be placed on other areas of the wearable vibration device. This embodiment allows for a more compact device.

FIG. 5B shows the top view of the device in FIG. 5A. FIG. 5C shows the side of the wearable vibration device which faces away from the user.

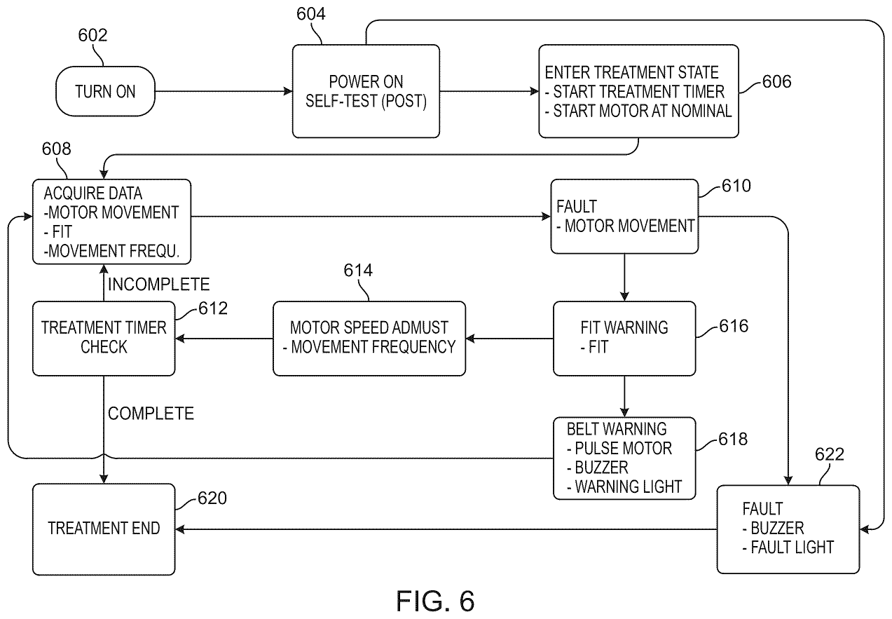

FIG. 6 shows a logical diagram of the function of an embodiment of the wearable vibration device. First, the device is turned on, represented by box 602. The processor then checks for faults, represented by box 604. Several components are checked including the battery, electronic communications, and other checks. If any fault is present, the processor moves to the fault handler box 622. For example, on startup a single fault may be enough to trigger the fault handler, however during operation, more than one fault may need to occur, either consecutively or within a certain time frame, to trigger the fault handler. If no faults are present, the processor moves on to enter the treatment state, represented by box 606. Entering the treatment state includes starting the treatment timer, starting the motor at a nominal setting, and may include other processes. During the treatment state, the processor may acquire data either intermittently, or continuously, such as motor movement, the fit of the device, and the movement frequency. This is represented by box 608. Fit may include feedback from one or more sensors, including, but not limited to contact sensor(s), pressure sensor(s), strain gauge(s), accelerometer(s), and gyroscope(s). Motor movement and motor frequency are determined by a motor sensor. It is also envisioned that fit may be assessed before the motor is turned on, either instead of, or in addition to, assessing fit after the motor is turned on.

If the motor movement is not in the appropriate range, a motor movement fault is triggered, represented by box 610. The appropriate range may be preset and may depend on the weight, height, age, sex etc. of the user, as well as the treatment type, area, time etc. The appropriate range may also be dynamically set based on the fit of the wearable vibration device and/or other factors. A fault in the motor movement may result in an audible buzzer or alarm, a visible light and/or other alarms.

If the fit is not in the appropriate or optimal range, a fit fault or warning is triggered, represented by box 616. The appropriate range for fit may be based on feedback from any of the sensors described herein. The appropriate/optimal range for fit may be set ahead of time, or may be dynamically set based on the fit of the wearable vibration device and/or other factors. The processor may check for fit on a periodic basis. For example, if the fit check returns two or more consecutive fit faults, the fit warning handler may be triggered. Fit warning handler is represented by box 618. A fault in the fit may result in a pulse alarm, which may be generated by pulsing the vibrational motor, an audible buzzer or alarm, a visible light and/or other alarms.

After hearing, feeling, seeing or otherwise perceiving a fit alarm, the user may either adjust the fit of the wearable vibration device, or the processor may adjust the motor movement as represented in box 614, or both. The frequency, amplitude and other motor parameters may be adjusted to optimize the treatment in response to the fit warning. The motor parameter adjustment may be a continual check occurring in the regular code loop. For example, if the motor frequency changes for whatever reason (fit, movement, activity, body position, time, etc) and is outside of a predetermined window away from a predetermined frequency (30 Hz for example) for a certain timer or counter: then the motor may adjust itself to correct for the error in frequency.

As treatment proceeds, the processor continually or intermittently checks the treatment timer, represented by box 612. If the treatment time is complete, the processor moves onto to box 620 and the treatment is ended. If the treatment time is incomplete, the processor of the wearable vibration device continues the treatment, and continues acquiring motor, fit, and/or other data until the treatment ends.

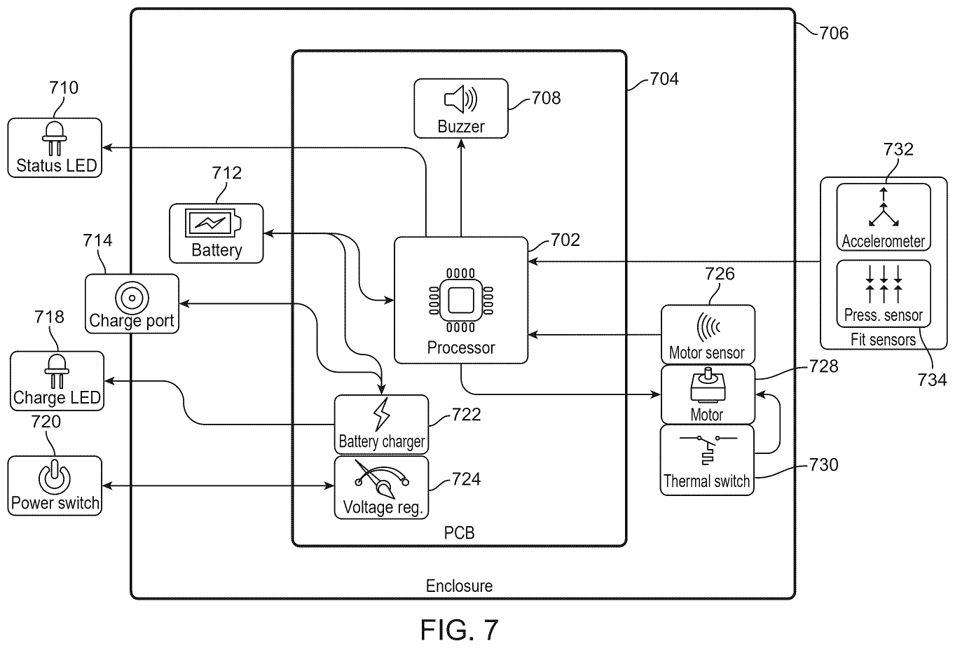

FIG. 7 shows a diagram of the various components of an embodiment of the wearable vibration device. Processor 702 includes the control electronics and is located on circuit board 704. The circuit board, along with other components, is within enclosure 706, for example, similar to enclosure 106 in FIG. 1. Also on the circuit board are buzzer 708, battery charger 722 and voltage regulator 724 linked to the battery. Inside the enclosure are also battery 712, motor 728, motor sensor 726 and thermal switch 730 linked to the motor. Motor sensor 726 may be in proximity to the motor to sense the motor's vibration and/or the motor's position with respect to gravity. Charge port 714 is located at the enclosure or container wall so that it can be accessed and the battery charged.

Outside of the enclosure are other components including power switch 720, charge LED 718, status LED 710 and any fit sensor(s). Fit sensors may include, but are not limited to, contact sensor(s), pressure sensor(s) 734, strain gauge(s), accelerometer(s) 732, and gyroscope(s).

Embodiments to treat other body areas are also envisioned. For example, vibration may be delivered to the foot through a shoe or sock like device, or a device that straps, or otherwise attaches to the foot or lower limb. Vibrational stimulus delivered to the foot or lower limb may help treat osteoporosis or other ailments.

It has also been shown that vibratory noise applied to the sole of the foot may improve sensation, enhance balance, and/or reduce gait variability. The vibratory noise, or energy, may be subsensory or may be sensed by the wearer. As in other embodiments, the application of vibration may be periodic, continuous, or otherwise.

Although embodiments have been described herein, other embodiments are envisioned. For example, the wearable vibration device may be designed to be worn on other areas of the body such as the neck, back, limbs, head etc. The vibrational energy may be configured to be directed in different directions, more than one direction, alternating directions, simultaneously different directions etc. More than one vibrational motor may be present in the device, allowing for more flexibility in directing vibrational energy in terms of direction, body part, etc. the vibrational energy may change with time, increasing/decreasing amplitude, increasing/decreasing frequency, changing direction, cycling through a program, turning on and off, etc. The stimulation vibration may also incorporate different kinds of waveforms. For example, square, triangle, saw tooth, sinusoidal waveforms, etc. These different waveforms may introduce harmonics of the base frequency and may provide enhanced or additional benefits. Multiple frequencies may also be superimposed on each other in the vibrating element. Multiple vibrational motors may be worn on different parts of the body. Multiple wearable vibration devices may be worn. Multiple vibrational motors may be used to partially or fully cancel, augment, or change the vibrational energy applied to the user. Vibrational energy may be transferred transcutaneously to an implanted metal plate. For example, the vibration device may be placed on the outer surface of the leg to vibrate a metal bone plate within the leg to reduce bone necrosis around the plate. This embodiment of the device may be used periodically, possibly once per day or once per week or once per month to reduce necrosis of the bone.

Embodiments of the wearable vibration device may be used for SI (sacroiliac) joint syndrome, SI joint arthrosis, SI joint instability, SI joint blockage, Myalgia and tendopathia in pelvic region, Pelvic ring instability, In the case of structural disturbance following lumbar spinal fusion, For prophylaxis of relapsing SI joint blockages and myotendopathia (m. rectus abdominis, m. piriformis adduktoren), Symphysis rupture and relaxation, back pain, cartilage strengthening, as well as other conditions.

FIG. 8 shows an embodiment of the vibration device which is in the form of a seat covering or pad. This embodiment includes the pad 802 itself, which may incorporate layers of foam or other padding, and plates 804 which are connected to the controller and vibrate. The plates may be metal, polymer, or any other suitable material. Preferably, the plates are rigid or semi-rigid. The plates may be shaped in a way to “cup” the bones of the buttocks to maximize the transmission of vibrational energy from the plates to the bones. The controller may be incorporated into the pad or may be a separate device, which controls the plates wirelessly or via wired connection. The user places the seat pad/covering on a chair, or other surface, and sits on top of the seat pad, so that the area of the buttock which includes the protruding bones that make up the ischium is in contact, or near contact with the plates. The plates may have a padded covering between the plate and the user. Vibrational energy is transmitted from the plates to the ischium and to the skeleton in general to transmit the vibrational energy to the lower back and hip area. The vibrational energy may be horizontal, vertical or both. In this embodiment, the weight of the user helps make sure the device is “fit” appropriately against the body. However, like other embodiments accelerometers may be used to assess “fit”. In some embodiments, the accelerometer reading may be correlated with treatment results to determine preferred accelerometer readings. The controller may control the vibration and force of the vibration device to optimize the accelerometer readings. A strap, or other connector, may be used to help secure the pad close to the body of the user.

The vibration device may also be in the form of a back pad, similar to the one shown in FIG. 8, but meant to be placed against the back of a chair with the plate areas of the device in contact with the hip bones, for example, the iliac. In this embodiment, a strap may be included to increase the proximity of the vibration device to the hip bone arca.

The vibration device may also be in the form of a weighted lap pad, with vibrational plate areas in proximity to the iliac crest areas of the hip bones.

Vibrational treatments may also be performed in forces and frequencies to treat constipation, and other digestion disorders.

FIG. 9 shows an embodiment of the vibration device which includes foam platform 902 with foam protuberance 904. The protuberance is shown here as a tapered square, but it may be rectangular, circular, oval, rounded, etc. The protuberance may be tapered or not tapered. The protuberance may take up a small portion, a large portion, or essentially all of the surface area of the platform. The foam platform and protuberance are designed to increase comfort of the user, increase the likelihood of proper placement over the sacrum, and allow transference of the vibrational energy from the motor to the sacrum of the patient. The platform and/or protuberance may be made from a high density polymer foam, such as a crosslinked poly ethylene foam. An example is provided below:

Crosslinked PE Foam:

| PROPERTY | AVE VALUE | UNIT |
|---|---|---|
| Density | 35-42 | Kg/m³ |
| Bun Size | 2000 × 1000 | |
| Thickness | 0.5-100 | mm |
| Hardness | 18-23 | Asker C |
| Tensile Strength | 252 | Kpa |
| Elongation at Break | 220 | % |
| Tear Strength | 1.75 | kN/m |
| Temperature Range | −50/80 | ° C. |
| Water Absorption | 3 | % |
| Thermal Conductivity | 0.04 | W/mk |
| 25% Compression Deflection | 45 | Kpa |
| 50% Compression Set | ≤20 | % |

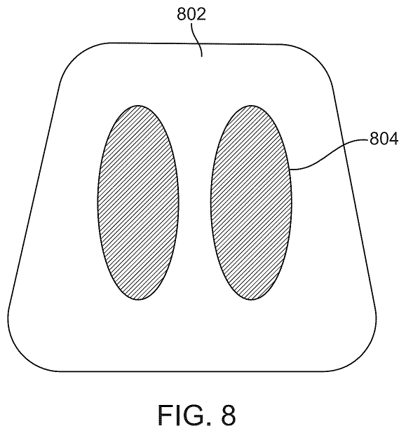

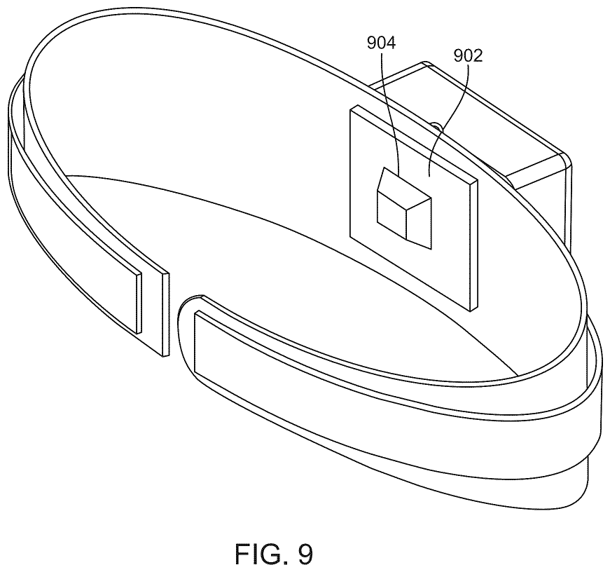

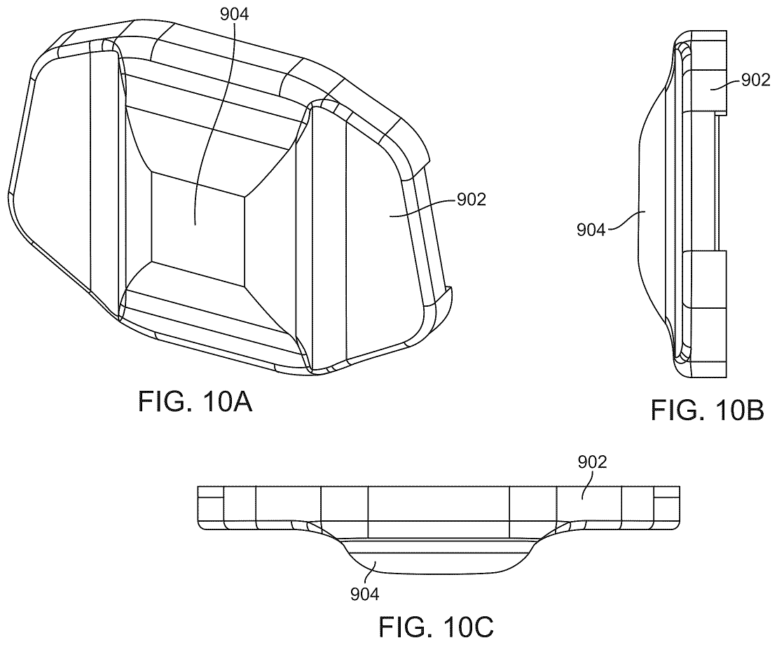

FIGS. 10A-C show different views of another embodiment of the foam platform and protuberance.

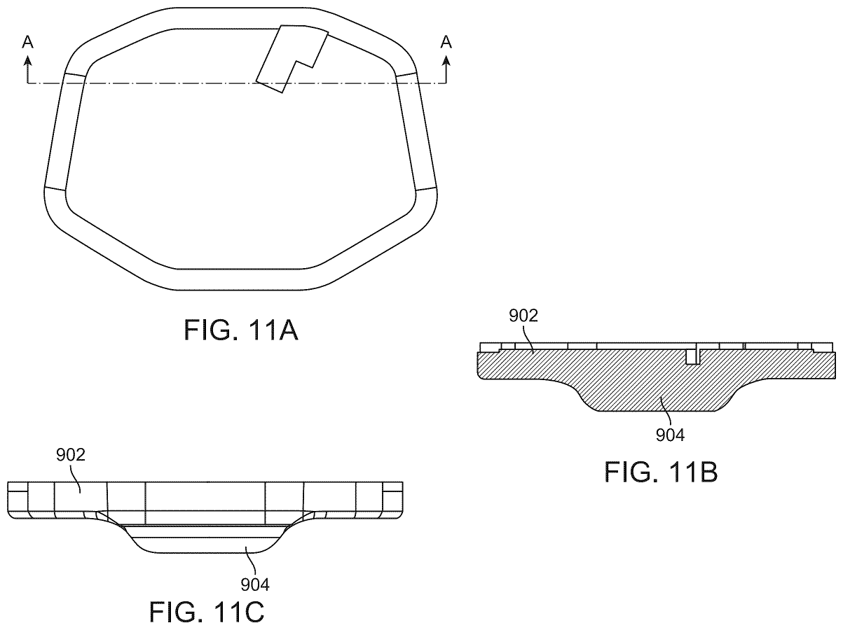

FIGS. 11A-C show different views of another embodiment of the foam platform and protuberance, along with some example dimensions in inches.

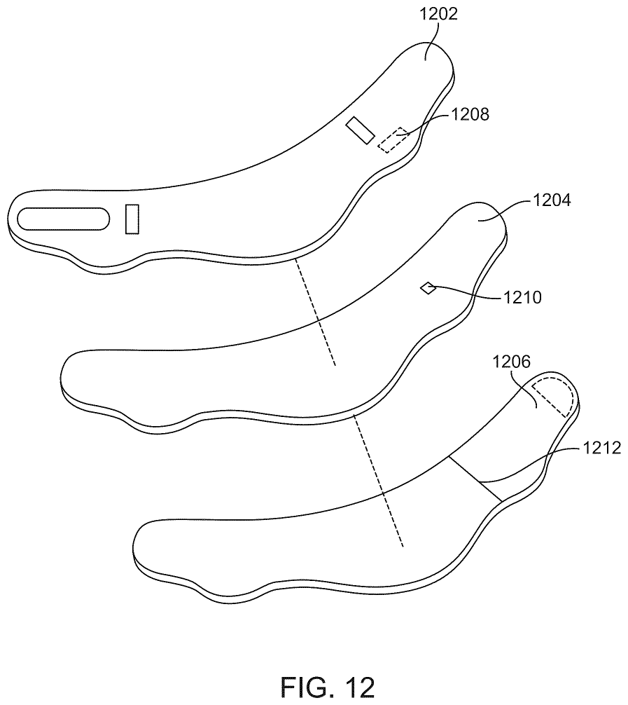

FIG. 12 shows an embodiment of the belt of the device. The belt shape and construction is meant to maximize patient comfort while providing transmission of vibration from the pack to the patient. A parabolic contour may be used so that the best is more form fitting. When the belt is worn, it fits snugly around the waist and wider over the hips. In addition, this contour facilitates correct placement of the belt.

The belt itself may be comprised of several layers of neoprene, to which various fasteners, stays (nylon webbing loops), a zipper, and pockets may be added. Each layer of neoprene may have a thin nylon fabric laminated on either side. The middle structural layer 1204, which may be about 3 mm thick, supports most of the weight of the vibration pack and provides some rigidity. The outer and inner layers, 1202 and 1206, of neoprene may be about 1 mm thick. During assembly, the layers may be stacked and then the edges may be bound together with a thin nylon strip. Neoprene and nylon may be used due to their elasticity, so that the belt optimally conforms to various anatomies, and established use in skin-contacting apparel and athletic products. Patients may be instructed to wear the belt over a layer of clothing. Also shown in FIG. 12 are accelerometer pocket 1210, invisible zipper opening 1212 and user interface board pocket 1208. The user interface board may include an on/off button, a battery level indicator, and an alarm indicator, which may be used for various parameters such as fit, treatment time, treatment level, treatment limit etc.

Final assembly of the belt may be completed using the access zipper 1212 on the back side. The vibration pack may be rigidly fixed to the middle structural layer by compressing the middle layer between the vibration pack and a metal plate. When assembly is complete, the zipper may be locked in place to prevent access to components and wiring.

Belt dimensions for the three sizes were chosen based on average female dimensions in the US. The mean hip size for women in our target population, from ages 46-66+, is approximately 44″, with standard deviation of about 4.5″. Therefore, assuming a normal distribution, the device size range (across three sizes) of 35″-54″ should accommodate approximately 95% of the US female population.

The vibration pack may generate vibration using a powered eccentric-rotating-mass motor controlled by pulse-width modulation (PWM). The duty cycle of the motor PWM can be changed to tune rotation frequency, which also changes vibration amplitude (motor frequency and vibration amplitude are approximately linearly proportional over the motor frequency range of 15-50 Hz). The motor may be attached to, and oriented within, the pack to transmit vibration to the patient, with the vibration primarily being in the sagittal plane (x-and z-axes, where the z-axis is parallel to the patient's height axis/long body axis).

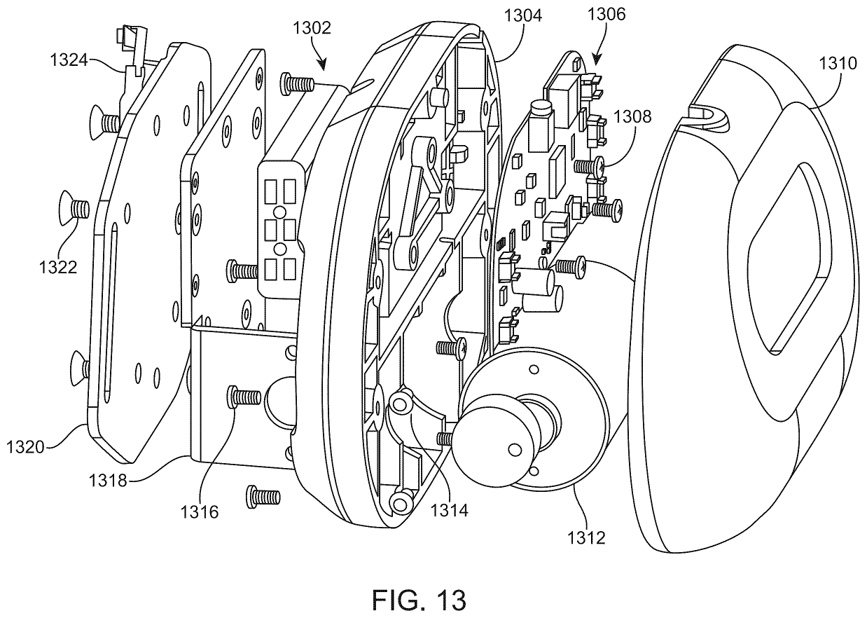

FIG. 13 shows an embodiment of the vibration pack. Shown are battery 1302, bottom half of housing 1304, printed circuit board assembly (PCBA) 1306, screws 1308, top half of housing 1310, motor 1312, screws 1314, screws 1316, motor mount plate 1318, back plate 1320, belt attachment screws 1322, pressure, or force sensor 1324. The housing may comprise be made of ABS (Acrylonitrile Butadiene Styrene Plastic) housing. The plates may be 0.1″ aluminum plates.

The vibration pack is mounted to the belt via back plate 1320. The neoprene of the belt is sandwiched between back plate 1320 and motor mount plate 1318 using six screws.

The contact surface between the vibration pack and the patient (between the back plate above and the patient) may be padded by a piece of 0.5″ dense polyethylene foam. The foam serves the purpose of making the belt more comfortable as well as ensuring better contact (more surface area) between the vibration pack's force sensor and the patient's body. In addition, the foam serves as a landmark on the belt for correct placement over the patient's sacrum. The foam is dense enough that it does not significantly attenuate vibration transmitted to the body, which is important for achieving the target therapeutic level.

The vibration pack shown also contains a PCBA, which has device control hardware including a microprocessor, real time clock (RTC), motor control chip, battery charge chip, an accelerometer, flash memory chip, and a Bluetooth Low Energy (BLE) module, in addition to supporting hardware (voltage regulators, operational amplifiers, etc). Motor performance is monitored by an on-board motor control chip, including safety features such as a current sensor (which electronically reduces the motor speed if the current draw is higher than permitted). As a backup safety mechanism, the board has hardware fuse which trips if the current draw exceeds 2.2 A, thereby shutting down the device.

Vibrational energy may be at a frequency of about 30-90 cycles per second (Hz). Other frequency ranges are also contemplated such as 1-100 HZ and other sub-ranges therein, such as, 25-35 Hz, or 20-40 Hz, or 10-50 Hz, including specific frequencies therein, such as about 30 Hz, or about 20 Hz, or about 10 Hz or about 4 Hz. The intensity can range from 0.01 g to 10 g (where 1.0 g=earth's gravitational field=9.8 m/s/s), and other sub-ranges therein, such as 0.01 g to 4.0 g, and specific magnitudes therein, such as about 0.3 g or about 1.0 g.

The vibration device may have several sensors to monitor device usage and performance. An accelerometer may be embedded within the neoprene belt approximately over where the patient's right iliac crest is located while worn. This accelerometer may be used to quantify transmission of acceleration from the pack to the patient, and the motor speed may be adjusted to ensure that the transmitted vibration magnitude is within the range of what is safe and therapeutic. A second accelerometer may be located on the PCBA proximal to the motor, where it may be used to monitor motor activity directly. The accelerometers may utilize MEMS (Micro-Electro-Mechanical Systems) technology, making them extremely small and reliable. The digital sensors may have a maximum range of ±16 g (although this range is set to ±4 g in practice to increase sensitivity) and may be capable of high resolution data rates up to 1.6 kHz.

To ensure adequate belt tightness for proper transmission of the vibration to the patient, a force, or pressure sensor may be is located at the interface between the patient and the pack (in this embodiment it is located behind the foam padding) to monitor pack force against the sacrum. If the belt tightness is insufficient before turning on the motor or if the belt tightness drops below a threshold during use, the motor may not turn on or stop during use, respectively.

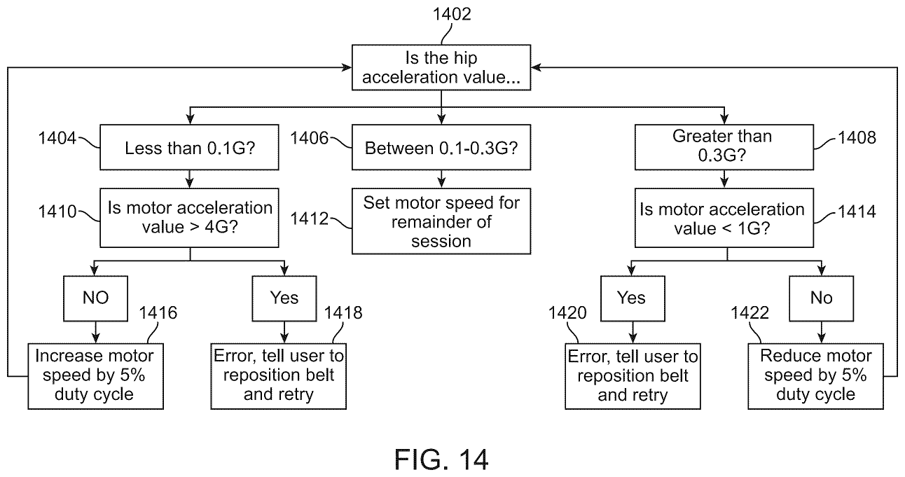

The vibration device may have an “auto-calibration” feature to ensure that the patient is receiving a safe and therapeutic level of vibration with each use. A feedback loop can read the value of the belt-mounted accelerometer, identify if the reading is within a specified window, and either increase or decrease the power supplied to the motor until the belt-mounted accelerometer reads within the specified window. A control logic of some embodiments is represented by the flowchart in FIG. 14.

As shown in FIG. 14, the controller can manage cases where the hip accelerometer reading is artificially low (for example, in the case where the belt is not worn on the body) or artificially high (for example, if the patient is jumping up and down). The controller checks whether the hip accelerometer value is consistent with an expected motor accelerometer value before continuing to adjust the motor power. Box 1402 represents the controller checking the acceleration sensed by an accelerometer at the hip. If the value is below a threshold, for example, 0.1 g, as shown in box 1404, the controller checks the motor acceleration at box 1410. If the motor acceleration is above a threshold, for example, 4 g, the controller will issue an error instructing the user to reposition the device and try again, as represented by box 1418. If the motor acceleration is below a threshold, for example 4 g, the controller may increase the motor speed, for example, by 5% of the duty cycle, as shown at box 1416.

If the acceleration at the hip is above a threshold, for example 0.3 g, as is represented by box 1408, the controller may check the motor acceleration, as represented by box 1414. If the motor acceleration is below a threshold, for example 1 g, the controller will issue an error to the user, instructing the user to reposition the device and try again, as represented by box 1420. If the motor acceleration is above a threshold, for example 1 g, the controller may reduce the motor speed, for example by 5% of the duty cycle, as shown at box 1422.

If the acceleration measured at the hip is between two threshold levels, for example, 0.1 g and 0.3 g, as represented by box 1406, the controller will maintain the speed of the motor, as shown at box 1412.

If the belt and motor readings are inconsistent with each other (ratio of acceleration values (motor:belt) is below 2.0 or above 25.0), the system will not proceed to the treatment and will provide instructions to reposition the belt and to stand still during the short calibration process. In addition, to mitigate the effects of noisy accelerometer data caused by patient movement during the calibration process, it is possible to filter the data in real-time to obtain the most accurate readings. If the hip accelerometer readings (before calibration) are outside of the specified ranges over successive uses (indicating inconsistent application of the device/noncompliance with device instructions), the device can alert the patient to seek additional training/technical support.

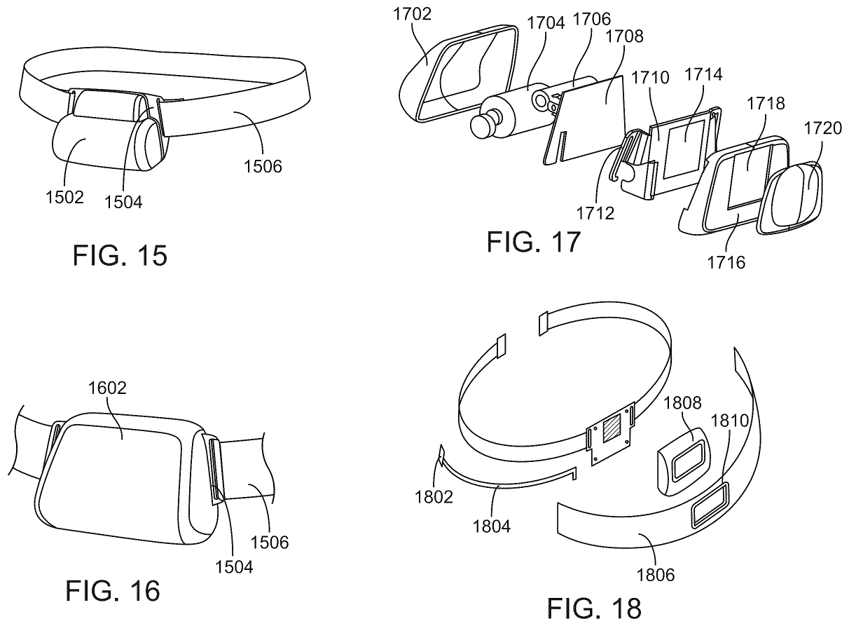

FIGS. 15 and 16 show 2 different embodiments of the wearable vibration device. These include housing versions 1502 and 1602, strap anchors 1504 and strap or belt 1506.

FIG. 17 shows an expanded view of the embodiment shown in FIG. 16. Shown here are front housing 1702, vibrating motor 1704, battery 1706, PCB (printed circuit board) 1708, back plate 1710, strap anchors 1712, pressure or force sensor 1714, back housing 1716 with back housing window 1718 and foam pad 1720. Window 1718 allows for direct contact between pressure sensor 1714 and foam pad 1720. In some embodiments, foam pad 1720 may be on the opposite side of back housing 1716 and the protrusion of the foam pad may protrude through window 1718. In some embodiments, foam pad 1720 is disposable and/or replaceable. Motor 1704 may attach directly to back plate 1710.

FIG. 18 shows an embodiment of the device with a window in the fabric outer layer through which the housing of the vibration device may be accessed. Shown here are accelerometer 1802, accelerometer lead 1804, front housing 1808, outer layer 1806 and window 1810. The user interface and/or other components of the housing of the device may be accessible through the window by the user when the belt is assembled. The accelerometer may be positioned to sit over the iliac crest of the hip to measure bone acceleration. The location of the accelerometer may be adjustable for people of different sizes.

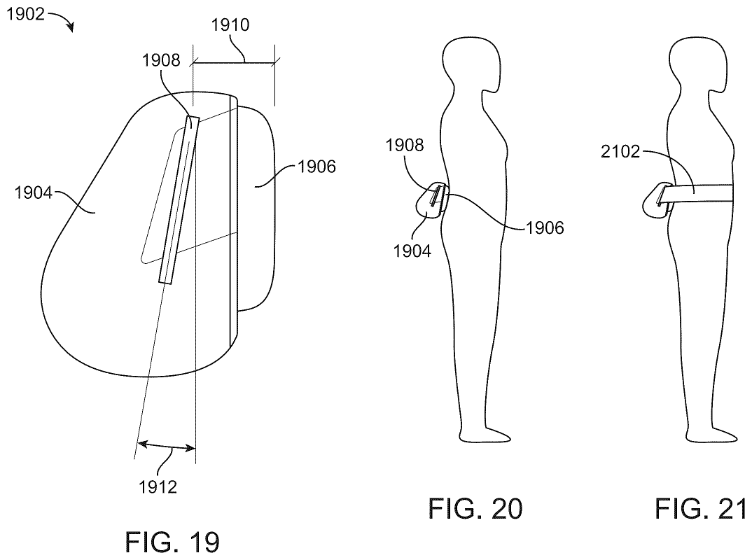

FIG. 19 shows a side view of an embodiment of wearable vibration device 1902. Shown here are housing 1904, foam pad 1906, and strap anchor 1908. A second strap anchor on the opposite side is not shown. Strap anchor 1908 is shown distance 1910 from the outer surface of foam pad 1906 and set at angle 1912 from vertical. Distance 1910 and angle 1912 may help with the comfort, fit and effectiveness of the device when it is in place and operating.

Distance 1910 may be around 0.5″ to around 1.0″. Alternatively, distance 1910 may be around 1.0″ to around 1.5″. Alternatively, distance 1910 may be around 1.0″ to around 2.0″. Alternatively, distance 1910 may be around 0.5″ to around 2.0″. Alternatively, distance 1910 may be around 0.5″ to around 3.0″. Alternatively, distance 1910 may be around 1.0″ to around 3.0″.

Angle 1912 may be around 8°-12°. Alternatively, angle 1912 may be around 9°-11°. Alternatively, angle 1912 may be around 7°-19°. Alternatively, angle 1912 may be around 10°-13°. Alternatively, angle 1912 may be around 5°-15°. Alternatively, angle 1912 may be around 5°-20°.

FIGS. 20 and 21 show the embodiment of the device shown in FIG. 19 in place on a subject, to illustrate the placement of strap anchor 1908. FIG. 20 does not include strap 2102 in the illustration, while FIG. 21 does include strap 2102.

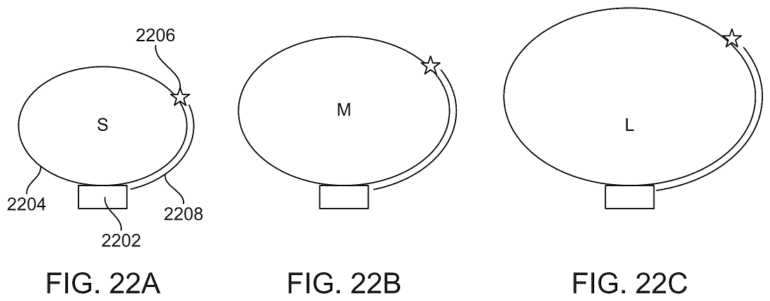

FIGS. 22A-22C show possible locations of an accelerometer on the device. An accelerometer may be used to measure acceleration at the iliac crest of the hip, for calibration purposes, fit purposes, and/or ongoing treatment assessment purposes or other purposes. Shown here is device housing 2202, band or strap 2204, accelerometer 2206 and accelerometer lead 2208. Accelerometer lead 2208 may be of fixed length, may be of different lengths for different sized belts for different sized users, may be adjustable length and/or may be flexible to accommodate different lengths and different sized/shaped users. FIGS. 22A, 22B and 22C show examples of small, medium and large users and devices respectively. The distance between the center of housing 2202 and accelerometer 2206, may be around 30.75 cm for a small size, around 36 cm for a medium size, and around 40.75 cm for a large size. Alternatively, the distance between the center of housing 2202 and accelerometer 2206, may be around 28-32 cm for a small size, around 34-38 cm for a medium size, and around 39-43 cm for a large size. Alternatively, the distance between the center of housing 2202 and accelerometer 2206, may be around 25-35 cm for a small size, around 30-40 cm for a medium size, and around 35-45 cm for a large size.

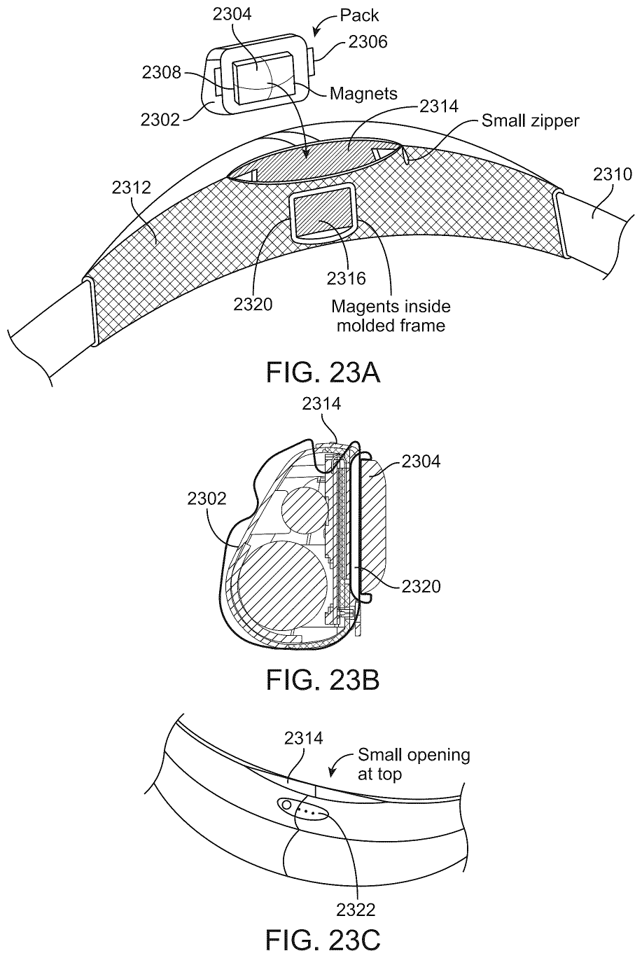

FIGS. 23A-C show another embodiment of the wearable vibration device. Shown here is motor housing 2302, foam pad 2304, strap anchors 2306, magnetic area 2308, strap or band 2310, covering 2312, opening 2314, frame 2320 and frame opening 2316. Also shown in FIG. 23C are device controls 2322. In this embodiment housing 2302 is sized to fit within opening 2314 of the belt. Housing 2302 may include magnetic area 2308 which contacts a magnetic area of frame 2316 to attach the housing to the frame of the belt. Alternatively only the housing or the frame may include magnets and the other may be include a magnetic material, such as metal. Alternatively, housing 2302 may attach to strap 2310 and/or covering 2312 with any suitable attachment mechanism, such as snaps, hooks, etc.

FIG. 23B shows a side view of housing 2302 within covering or pouch 2312. Foam pad 2304 is shown protruding through frame opening 2316 of frame 2320. Housing 2302 may be removable/replaceable within covering 2312 so that the covering may be washed or replaced. The motor/motor housing may be used with coverings and/or straps which are available in different sizes. Strap or band 2310 may also be available in different sizes and be fully separate from housing 2320. Strap 2310 may or may not be incorporated with covering 2312. Strap or band 2310 and covering 2312 may be referred to as the securing mechanism, and may be separatable from the motor housing.

Housing 2302 may be inserted and extracted from covering 2312 via opening 2314. Opening 2314 may be closed with a zipper, Velcro, snaps or other closure mechanism. Controls 2322 may be incorporated into covering 2312 or may be incorporated into housing 2302 or both. If the controls are incorporated into the housing, they may be accessible through an opening in the covering or through a thin membrane in the covering.

Motor housing 2302 may reside in a pouch within belt. In other words, covering 2317 may be or incorporate a pouch to accept the motor housing and hold it in place for treatment. The motor housing may be removed from the pouch via opening 2314.

The patient may control the device through a simple user interface (UI) on the front of the belt or in a remote controller such as a mobile phone, computer, or tablet. For example, a power button may be used to switch the device on and off. Two light-emitting diodes (LEDs) may indicate normal operation and notify the patient of any suggested actions (tighten the belt, charge the device, etc.) or of any device-related issues, in which case they would contact technical support. In addition, a speaker in the vibration pack allows for audible notification of any status updates requiring the patient's attention.

The vibration device may be designed to mitigate potential safety risks and ensure effectiveness by incorporating the following features:

Sensor for proper belt fit. On the patient-side of the pack, a force or pressure sensor may be positioned between the pack and the foam, or elsewhere. This force sensor ensures that the belt is tight enough for effective vibration transmission to the patient yet not overly tight as to create discomfort while wearing the device. The optimal range for belt-fit force sensor reading may be between 12.2 N and 20 N. If this range is used, the force reading must be within this range before the device motor starts to initiate a treatment session. While treatment is being administered, if the force reading falls outside of this range for over 30 seconds, the motor will stop and the belt tightness must be adjusted back within the range to continue treatment.

Automatic shut-off at the end of a treatment session. The vibration device ma have an internal timer that automatically turns off the motor after 18 minutes (or other set time, such as 20 minutes, or 30 minutes) of treatment has been administered. This ensures that the patient receives the correct daily treatment without over-exposure to vibration.

Overuse prevention. To further ensure that a patient does not self-administer treatments too frequently, which could provide over-exposure to vibration, the vibration device controller may restricts the total treatment duration to 18 minutes (or other set time) per calendar day. If a patient manually forces the device off before the set treatment session time has completed or if the force sensor reading goes out of range during treatment and the device shuts off automatically, the patient will can start another treatment on the same calendar day, but the device may automatically shut off when 18 total cumulative minutes of treatment is reached for that day.

Automatic tuning of the vibration magnitude at the start of each treatment session. While features may be designed into the vibration device to standardize vibration transmitted from the motor to the patient, multiple patient factors may affect this transmission. These factors include patient anatomical parameters that vary between individuals and within an individual over time, such as body shape, size, composition, and weight, as well as belt application variability from day-to-day that could impact belt tightness. To ensure that the vibration dose administered to the patient is consistent and both safe and effective/therapeutic for the intended use, the applied vibration may be tuned at the beginning of each treatment session. Vibration dose can be altered via modifying the motor frequency (for example, within a range of 20-40 Hz). Vibration dose may be measured with the belt accelerometer, which is located at the patient's right iliac crest. When the patient puts the vibration device on, the motor may begin at the frequency of the previous session, and the controller may determine the vibration magnitude. If the measured vibration magnitude is outside of the specified range (for example, 0.03-0.10 g, RMS (root mean square)), the frequency is increased or decreased by an increment, such as 5 Hz, as appropriate and the vibration magnitude is measured again. This continues until the measured vibration magnitude is within the specified range. If the limit of the frequency range is met without reaching the specified range, the device shuts off and the device warning light blinks to direct the patient to the Instructions for Use for troubleshooting guidance.

Maximum Daily Safe Exposure Level. ISO 2631-1 provides guidelines for safe levels of vibration transmitted through the body via the supporting structure when the individual is standing or sitting for 4-8 hr/day (e.g. heavy machine operators, factory workers). ISO 2631-1 also includes guidelines for extrapolating to shorter periods of exposure and alternate ways that the vibration is applied.

ISO 2631-1 (herein incorporated by reference in its entirety) provides guidelines for calculating a value for the equivalent vibration exposure, which is dependent on multiple factors, including the applied acceleration magnitude in three orthogonal directions, the frequency of the vibration, and the subject's body position during exposure.

### Maximum Daily Safe Exposure Level

The maximum daily safe exposure level is calculated based on both treatment time, and frequency level of the motor. To remain under the maximum safe exposures, the controller of the vibration device may limit the time and frequency that the user is exposed to during any 24 hour period. In other words, the controller of the vibration device may limit the cumulative vibration exposure of an individual in a 24 hour period to make sure it is under the recommended maximum vibration exposure, given all the relevant parameters. To achieve this, the controller may take into consideration the frequency of the motor, and set a maximum 24 hour cumulative exposure time. Or, the controller may simply limit the cumulative exposure time within any 24 hour period to around 18 minutes, around 20 minutes or around 30 minutes. The controller may limit the exposure by not allowing the device to function during a 24 hour period once the limit has been reached. Alternatively or additionally, the device may alert the user that the limit has been reached. The device would function again after the 24 hour period. Possible cumulative time limits may be around 15-20 minutes, 20-30 minutes, 30-40 minutes, 40-60 minutes etc. The frequency of the motor may or may not be taken into consideration in the determination of these limits. Other factors that may be taken into consideration, and may be entered into the controller of the system, include: parameters sensed by any sensors on the system, including accelerometers, pressure or force sensors, etc. For example, if the vibrational exposure for 30 minutes were 0.330 g RMS (peak to peak×0.7 approx. for sinusoidal signals), the vibration device could be tuned (by using sensor info) to deliver around 0.1-0.3 g peak to peak vibration. Alternatively, the sensors may be monitored to determine the delivered vibration, and the controller may limit the exposure time accordingly.

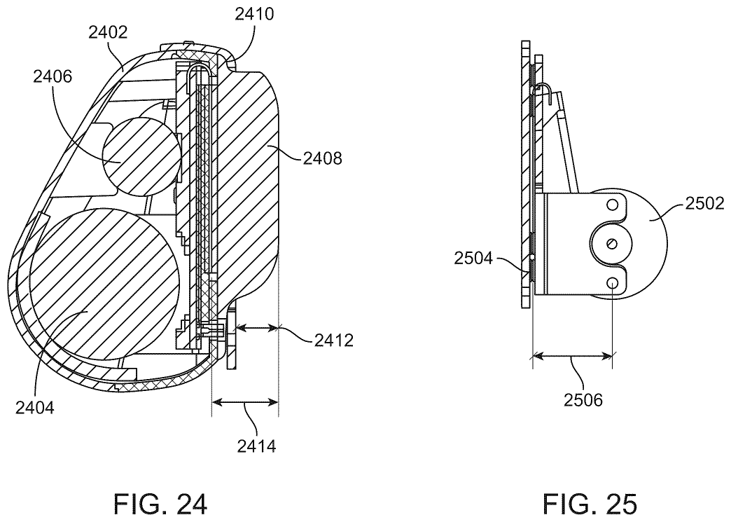

FIGS. 24 and 25 show cross-sectional side-view detail of another embodiment of the wearable vibration device. FIG. 24 shows housing 2402, motor 2404, battery 2406, back housing 2410 and foam pad 2408. Distance 2412 is the distance between the back of the foam pad and the back of the back housing, or the protrusion distance of the foam pad. Protrusion distance 2412 may be around 10.0-10.3 mm. Alternatively, protrusion distance 2412 may be around 10.0-10.5 mm. Alternatively, protrusion distance 2412 may be around 9.5-10.5 mm. Alternatively, protrusion distance 2412 may be around 9.0-11.0 mm. Alternatively, protrusion distance 2412 may be around 5.0-15.0 mm. Alternatively, protrusion distance 2412 may be around 10.0-20.0 mm. Alternatively, protrusion distance 2412 may be around 20.0-30.0 mm. Alternatively, protrusion distance 2412 may be around 5.0-50.0 mm. Alternatively, protrusion distance 2412 may be around 1.0-5.0 mm. Distance 2414 is the distance between the back of the foam pad and the pressure or force sensor. Distance 2414 may be around 15.5-16.0 mm. Alternatively, distance 2414 may be around 15.0-16.0 mm. Alternatively, distance 2414 may be around 14.0-20.0 mm. Alternatively, distance 2414 may be less than around 20.0 mm. Alternatively, distance 2414 may be less than around 16.0 mm. Alternatively, distance 2414 may be less than around 10.0 mm. Alternatively, distance 2414 may be less than around 5.0 mm.

FIG. 25 shows the distance between the center of motor 2502 and force or pressure sensor 2504. Distance 2506 may be around 25.0-30.0 mm. Alternatively, distance 2506 may be around 20.0-35.0 mm. Alternatively, distance 2506 may be around 10.0-20.0 mm. Alternatively, distance 2506 may be around 5.0-10.0 mm. Alternatively, distance 2506 may be around 30.0-40.0 mm. Alternatively, distance 2506 may be around 5.0-40.0 mm. Alternatively, distance 2506 may be around 40.0-60.0 mm.

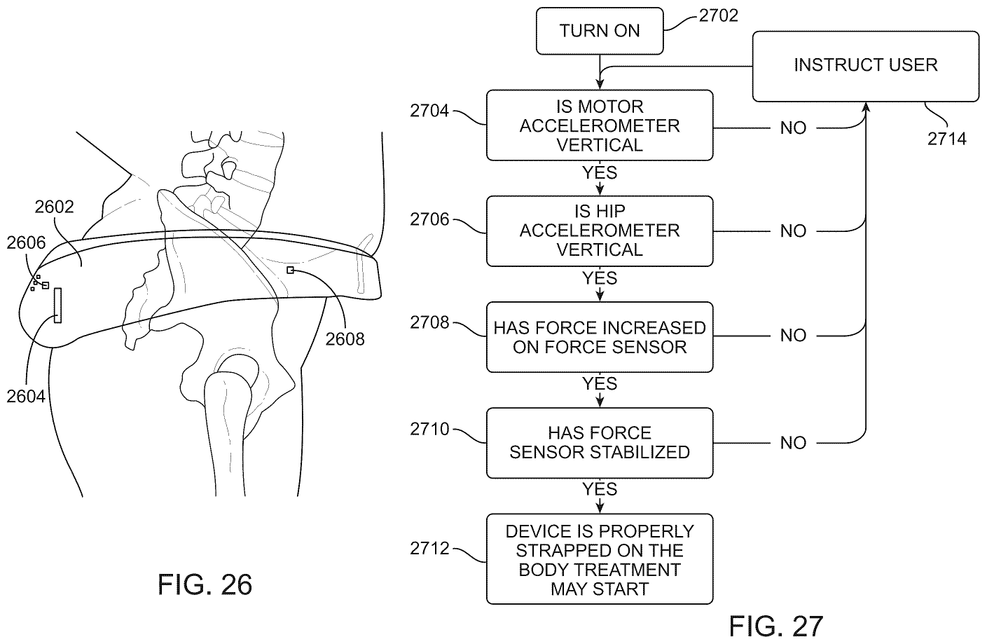

FIGS. 26 and 27 show the steps that the controller steps through to determine whether the wearable vibration device is properly strapped to the user before treatment is initiated. FIG. 26 shows possible approximate locations on wearable vibration device 2602 for force or pressure sensor 2604, motor sensor or accelerometer 2606 and hip sensor or accelerometer 2608.

FIG. 27 shows the steps that the controller steps through after the device has been turned on (step 2702) to ensure the device is ready for treatment. Step 2704 is a confirmation from motor sensor 2606, received by the controller, that the motor sensor is or is not relatively vertical. If the motor sensor is not relatively vertical, the controller may alert the user and may provide instructions, such as “move the belt upward” or “move the belt down further on hips” or “tighten the belt” or other instructions. If the motor sensor is relatively vertical, the controller will go on to the next step, step 2706.

Step 2706 is a confirmation from hip sensor 2608, received by the controller, that the hip sensor is or is not relatively vertical. If the hip sensor is not relatively vertical, the controller may alert the user and may provide instructions, such as “make sure you are standing” or other instructions. If the hip sensor is relatively vertical, the controller will go on to the next step, step 2708.

Step 2708 is a confirmation from force or pressure sensor 2604, received by the controller, that the force or pressure sensor has or has not sensed an adequate increase in force or pressure. An adequate increase in force or pressure is indicative of the device being snuggly strapped into place. If the force sensor does not sense adequate force, or an adequate increase in force, the controller may alert the user and may provide instructions, such as “tighten the belt” “loosen the belt” or “stand still” or other instructions. If the force sensor senses adequate force or increase in force, the controller will go on to the next step, step 2710.

Step 2710 is a confirmation from force or pressure sensor 2604, received by the controller, that the force or pressure sensor signal has or has not stabilized. If the force sensor does not sense adequate stabilization of force, the controller may alert the user and may provide instructions, such as “tighten the belt” or “stand still” or other instructions. If the force sensor senses adequate stabilization of force, the controller will go on to the next step, step 2712.

Steps 2704, 2706, 2708 and 2710 may be performed in any order, in parallel or serially. Step 2712 is performed by the controller after the controller receives feedback from steps 2704, 2706, 2708, 2710 indicating that all are true. All of the steps (steps 2704, 2706, 2708 and 2710) may not be required in some embodiments to move on to step 2712.

Steps 2704 and 2706 may determine whether the sensors are vertical (with respect to gravity) within a tolerance of 1 degree, 3 degrees, 5 degrees, 10 degrees, 15 degrees, 20 degrees, 30 degrees, 40 degrees, 50 degrees, 60 degrees or any appropriate tolerance. Step 2708 may determine whether an adequate force or pressure is sensed by comparing the sensed force to a force or pressure threshold. Step 2708 may additionally determine whether the force sensed by the force or pressure sensor is too high, indicating that the device is strapped on too tightly. Step 2708 may be performed in combination with, or after, step 2710. For example, step 2710 may require that the variation of the magnitude, or other parameter, of the force or pressure sensor readings be within a threshold before determining step 2710. Alternatively, or additionally, step 2710 may be determined first, and then step 2708 determined. The controller may iterate between steps 2710 and 2708 to determine whether both are true.

If all four of the steps are true (steps 2704, 2706, 2708, 2710), the controller may determine that the device is properly strapped to the user and thereafter, start treatment.

If any of steps 2704-2708 are not true, the controller may instruct the user to adjust the device on the body (step 2714). The controller may give more specific instructions depending on which step failed. For example, if step 2708 or step 2710 fails, the controller may instruct the user to tighten the straps of the device to make it more snug against the body (if the force signal is too low or not stable), or loosen the straps if the device is too tight against the body (if the force signal is too high). If steps 2704 or 2706 fail, the controller may instruct the user to adjust the position of the device on the body.

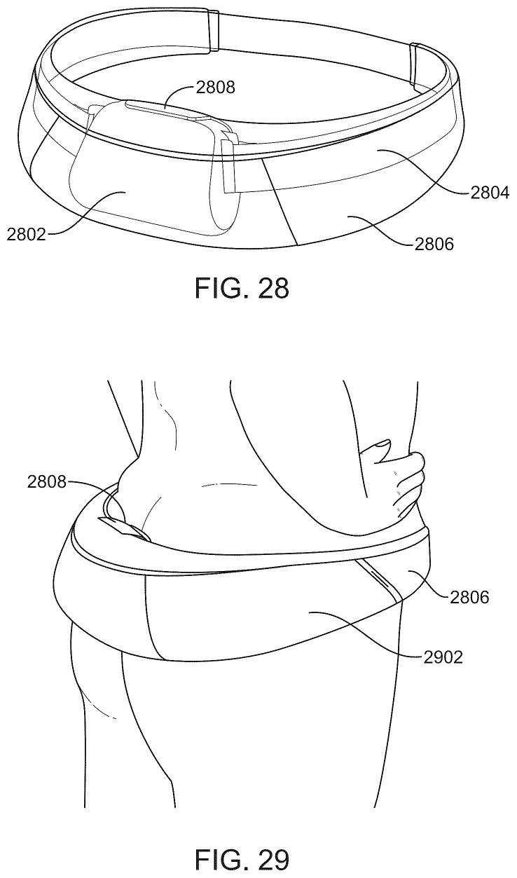

FIG. 28 shows an embodiment of wearable vibration device 2802 with flexible covering or enclosure 2806. The flexible enclosure may improve the aesthetics of the device, and may be made from fabric and/or foam or other appropriate material. Also shown here are straps 2804 for securing the device to the body, and device indicator/control panel 2808.

FIG. 29 shows an alternative view of the device in FIG. 28. Also shown here is pocket 2902. The pocket may be mesh or fabric or other material, and may zip closed. The pocket may stretch to accommodate larger items. The pocket may be used for a water bottle, or any other items. The shape and contours of flexible enclosure 2806 may help orient the wearable vibration device against the user so that the device is placed properly for treatment.

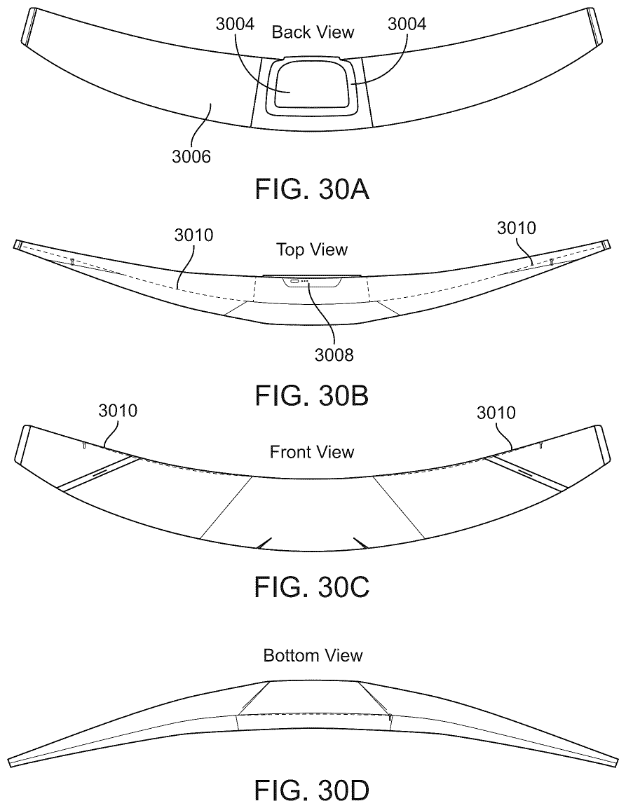

FIGS. 30A-30D show various views of an embodiment of the wearable vibration device. FIG. 30A shows a back view of the device. FIG. 30B shows a top view of the device. FIG. 30C shows a front view of the device. FIG. 30D shows a bottom view of the device. Shown here are back housing 3002, foam pad 3004, flexible enclosure 3006, indicator/control panel 3008, and pockets 3010.

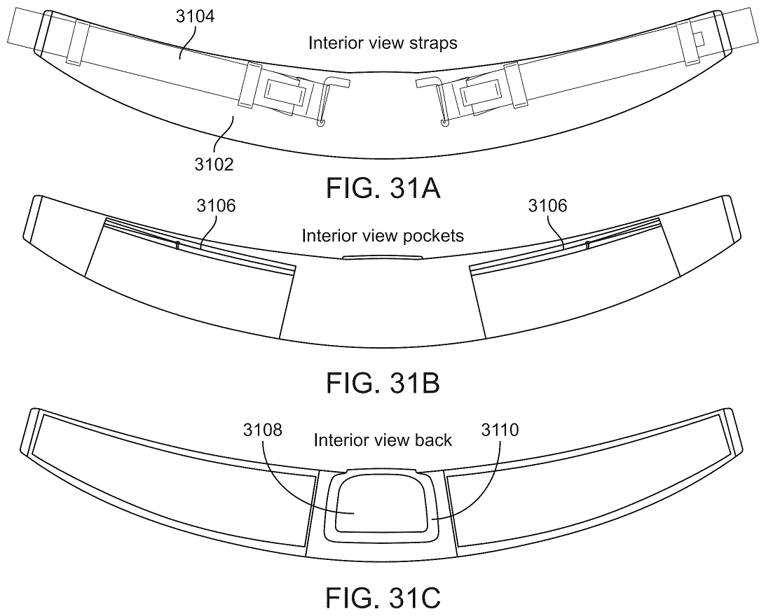

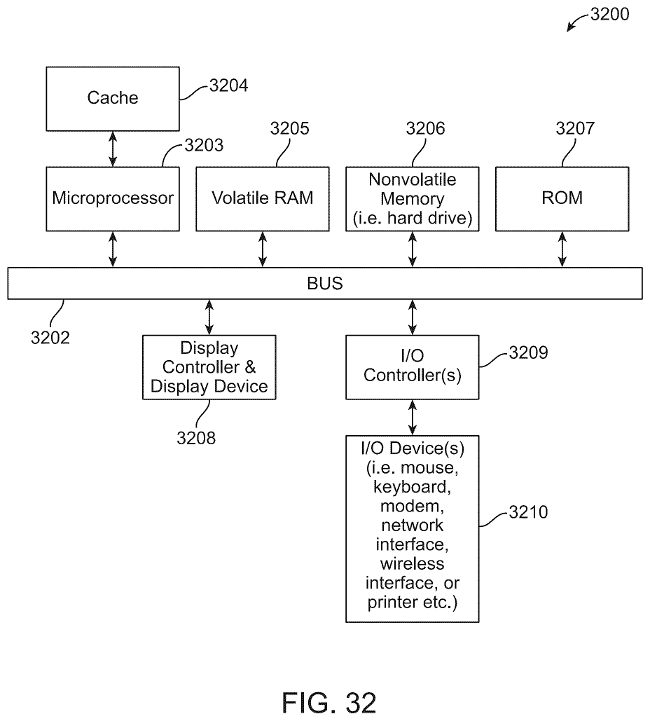

FIGS. 31A-31C show various views of an embodiment of the wearable vibration device. FIG. 31A shows an interior view of the device, showing the straps. FIG. 31B shows an interior view of the device, showing the interior pockets. FIG. 31C shows an interior back view of the device. Shown here are flexible enclosure 3102, straps 3104, interior pockets, 3106, foam pad 3108 and back housing 3110.

### Example of Data Processing System

FIG. 32 is a block diagram of a data processing system, which may be used with any embodiment of the invention. For example, the system 3200 may be used as part of the processor. Note that while FIG. 32 illustrates various components of a computer system, it is not intended to represent any particular architecture or manner of interconnecting the components; as such details are not germane to the present invention. It will also be appreciated that network computers, handheld computers, mobile devices, tablets, cell phones and other data processing systems which have fewer components or perhaps more components may also be used with the present invention.

As shown in FIG. 32, the computer system 3200, which is a form of a data processing system, includes a bus or interconnect 3202 which is coupled to one or more microprocessors 3203 and a ROM 3207, a volatile RAM 3205, and a non-volatile memory 3206. The microprocessor 3203 is coupled to cache memory 3204. The bus 3202 interconnects these various components together and also interconnects these components 3203, 3207, 3205, and 3206 to a display controller and display device 3208, as well as to input/output (I/O) devices 3210, which may be mice, keyboards, modems, network interfaces, printers, and other devices which are well-known in the art.

Typically, the input/output devices 3210 are coupled to the system through input/output controllers 3209. The volatile RAM 3205 is typically implemented as dynamic RAM (DRAM) which requires power continuously in order to refresh or maintain the data in the memory. The non-volatile memory 3206 is typically a magnetic hard drive, a magnetic optical drive, an optical drive, or a DVD RAM or other type of memory system which maintains data even after power is removed from the system. Typically, the non-volatile memory will also be a random access memory, although this is not required.

While FIG. 32 shows that the non-volatile memory is a local device coupled directly to the rest of the components in the data processing system, the present invention may utilize a non-volatile memory which is remote from the system; such as, a network storage device which is coupled to the data processing system through a network interface such as a modem or Ethernet interface. The bus 3202 may include one or more buses connected to each other through various bridges, controllers, and/or adapters, as is well-known in the art. In one embodiment, the I/O controller 3209 includes a USB (Universal Serial Bus) adapter for controlling USB peripherals.

Alternatively, I/O controller 3209 may include IEEE-1394 adapter, also known as Fire Wire adapter, for controlling FireWire devices, SPI (serial peripheral interface), 12C (inter-integrated circuit) or UART (universal asynchronous receiver/transmitter), or any other suitable technology. Wireless communication protocols may include Wi-Fi, Bluetooth, ZigBee, near-field, cellular and other protocols.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

The processes or methods depicted in the preceding figures may be performed by processing logic that comprises hardware (e.g. circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Any of the features of any of the embodiments disclosed herein may be used with other embodiments.

What is claimed is:

1. A wearable apparatus for preserving or improving bone density, comprising:
a housing containing a motor and one or more vibrating elements which are configured to impart repeated mechanical loads to a body of a user when actuated by the motor;
one or more securing mechanisms for securing the housing to the user such that the housing is maintained against the body while maintaining portability;
a first accelerometer in proximity to the motor;
a controller in electrical communication with the first accelerometer, wherein the controller is configured to determine a vertical orientation of the motor relative to horizontal based on a first signal from the first accelerometer and wherein the controller is further configured to provide an indicator when the vertical orientation of the motor is beyond a threshold limit.

2. The apparatus of claim 1 wherein the one or more securing mechanisms are configured for securing the housing against a hip, femur, and/or spine of the user.

3. The apparatus of claim 1 further comprising a second accelerometer in electrical communication with the controller, wherein the second accelerometer is secured to the one or more securing mechanisms so as to become aligned with a hip of the user when the housing is secured to the user.

4. The apparatus of claim 3 wherein the controller is further configured to determine a vertical orientation of the hip of the user based on a second signal from the second accelerometer.

5. The apparatus of claim 4 wherein the controller is further configured to provide a second indicator when the vertical orientation of the hip is beyond a second threshold limit.

6. The apparatus of claim 4 wherein the controller is further configured to provide the indicator when the vertical orientation of the hip is beyond a second threshold limit.

7. The apparatus of claim 1 further comprising a force sensor in electrical communication with the controller, wherein the force sensor is configured to be positioned between the housing and the body of the user.

8. The apparatus of claim 7 wherein the controller is further configured to determine a force applied by the housing upon the body of the user based on a third signal from the force sensor.

9. The apparatus of claim 8 wherein the controller is further configured to provide a third indicator when the force is below a third threshold limit.

10. The apparatus of claim 8 wherein the controller is further configured to provide the indicator when the force is below a third threshold limit.

11. The apparatus of claim 8 wherein the controller is further configured to provide a fourth indicator when the force is unstable.

12. The apparatus of claim 8 wherein the controller is further configured to provide the indicator when the force is unstable.

13. The apparatus of claim 1 wherein the controller is further configured to determine a vertical orientation of the hip of the user based on a second signal from a second accelerometer secured to the one or more securing mechanisms so as to become aligned with a hip of the user when the housing is secured to the user.

14. The apparatus of claim 13 wherein the controller is further configured to determine a force applied by the housing upon the body of the user based on a third signal from a force sensor configured to be positioned between the housing and the body of the user.

15. The apparatus of claim 14 wherein the controller is further configured to determine a force applied by the housing upon the body of the user based on a third signal from a force sensor configured to be positioned between the housing and the body of the user.

16. The apparatus of claim 15 wherein the controller is further configured to provide a fourth signal based on the force sensor when the force is unstable.

17. The apparatus of claim 16 wherein the controller is configured to provide the indicator based on the first signal, second signal, third signal, or fourth signal where each signal is alone or in combination with one another.

18. The apparatus of claim 1 wherein the one or more securing mechanisms comprise a belt configured to be worn around the body of the user.

19. The apparatus of claim 1 wherein the housing is removable from the one or more securing mechanisms.

20. The apparatus of claim 19 wherein the housing is removably secured within a pouch along the one or more securing mechanisms.

21. The apparatus of claim 1 further comprising a foam pad attachable to the housing.

22. The apparatus of claim 21 wherein the one or more securing mechanisms define an opening through which the foam pad is extendable.

23. The apparatus of claim 1 wherein the housing is securable to the one or more securing mechanisms via a magnet.

24. The apparatus of claim 1 wherein the housing is securable to the one or more securing mechanisms via one or more snaps.

25. The apparatus of claim 1 wherein the housing is securable to the one or more securing mechanisms via one or more clips.

26. A wearable apparatus for preserving or improving bone density, comprising:
a housing containing a motor and one or more vibrating elements which are configured to impart repeated mechanical loads to a body of a user when actuated by the motor;
one or more securing mechanisms comprising a receiving channel for removably receiving the housing, wherein the receiving channel is positioned to maintain the housing against the body while maintaining portability;
a first accelerometer in proximity to the motor; and
a controller in electrical communication with the first accelerometer.

27. The apparatus of claim 26 wherein the one or more securing mechanisms are configured for securing the housing against a hip, femur, and/or spine of the user.

28. The apparatus of claim 26 wherein the controller is configured to determine a vertical orientation of the motor relative to horizontal based on a first signal from the first accelerometer and wherein the controller is further configured to provide an indicator when the vertical orientation of the motor is beyond a threshold limit.

29. The apparatus of claim 28 further comprising a second accelerometer in electrical communication with the controller, wherein the second accelerometer is secured to the one or more securing mechanisms so as to become aligned with a hip of the user when the housing is secured to the user.

30. The apparatus of claim 29 wherein the controller is further configured to determine a vertical orientation of the hip of the user based on a second signal from the second accelerometer.

31. The apparatus of claim 30 wherein the controller is further configured to provide a second indicator when the vertical orientation of the hip is beyond a second threshold limit.

32. The apparatus of claim 31 further comprising a force sensor in electrical communication with the controller, wherein the force sensor is configured to be positioned between the housing and the body of the user.

33. The apparatus of claim 32 wherein the controller is further configured to determine a force applied by the housing upon the body of the user based on a third signal from the force sensor.

34. The apparatus of claim 33 wherein the controller is further configured to provide a third indicator when the force is below a third threshold limit.

35. The apparatus of claim 34 wherein the controller is further configured to provide a fourth signal when the force is unstable.

36. The apparatus of claim 35 wherein the controller is further configured to provide a fourth indicator based on the force sensor when the force is unstable.

37. The apparatus of claim 36 wherein the controller is configured to provide the indicator based on the first signal, second signal, third signal, or fourth signal where each signal is alone or in combination with one another.

38. The apparatus of claim 26 wherein the one or more securing mechanisms comprise a belt configured to be worn around the body of the user.

39. The apparatus of claim 26 wherein the housing is removable from the one or more securing mechanisms.

40. The apparatus of claim 38 wherein the housing is removably secured within a pouch along the one or more securing mechanisms.

41. The apparatus of claim 26 further comprising a foam pad attachable to the housing.

42. The apparatus of claim 41 wherein the one or more securing mechanisms define an opening through which the foam pad is extendable.

43. The apparatus of claim 26 wherein the housing is securable to the one or more securing mechanisms via a magnet.

44. The apparatus of claim 26 wherein the housing is securable to the one or more securing mechanisms via one or more snaps.

45. The apparatus of claim 26 wherein the housing is securable to the one or more securing mechanisms via one or more clips.

46. A method of preserving or improving bone density, comprising:
providing one or more securing mechanisms for securing a housing to a body of a user such that the housing is maintained against the body while maintaining portability, wherein the housing contains a motor and one or more vibrating elements which are configured to impart repeated mechanical loads to the body when actuated by the motor;
receiving via a controller a first signal from a first accelerometer which is in proximity to the motor;
determining via the controller a vertical orientation of the motor relative to horizontal based on the first signal from the first accelerometer; and
providing an indicator when the vertical orientation of the motor is beyond a threshold limit.

47. The method of claim 46 wherein the one or more securing mechanisms are configured for securing the housing against a hip, femur, and/or spine of the user.

48. The method of claim 46 further comprising receiving via the controller a second signal from a second accelerometer in electrical communication with the controller, wherein the second accelerometer is secured to the one or more securing mechanisms so as to become aligned with a hip of the user when the housing is secured to the user.

49. The method of claim 48 further comprising determining via the controller a vertical orientation of the hip of the user based on the second signal from the second accelerometer.

50. The method of claim 49 further comprising providing a second indicator when the vertical orientation of the hip is beyond a second threshold limit.

51. The method of claim 46 further comprising receiving via the controller a third signal from a force sensor in electrical communication with the controller, wherein the force sensor is configured to be positioned between the housing and the body of the user.

52. The method of claim 51 further comprising determining via the controller a force applied by the housing upon the body of the user based on the third signal from the force sensor.

53. The method of claim 52 further comprising providing a third indicator when the force is below a third threshold limit.

54. The method of claim 52 wherein the controller is further configured to provide a fourth signal when the force is unstable.

55. The method of claim 54 wherein the controller is further configured to provide a fourth indicator based on the force sensor when the force is unstable.

56. The method of claim 55 wherein the controller is configured to provide the indicator based on the first signal, second signal, third signal, or fourth signal where each signal is alone or in combination with one another.

57. The method of claim 46 wherein the housing is removable from the one or more securing mechanisms.

58. The method of claim 57 wherein the housing is removably secured within a pouch along the one or more securing mechanisms.

59. The method of claim 57 wherein the housing is securable to the one or more securing mechanisms via a magnet.

60. The method of claim 57 wherein the housing is securable to the one or more securing mechanisms via one or more snaps.

61. The method of claim 57 wherein the housing is securable to the one or more securing mechanisms via one or more clips.
